(19) United States
(12) Patent Application Publication
(10) Pub. No.: US 2026/0284614 A1
(43) Pub. Date: Sep. 24, 2026

(54) Universal Construction for Storing, Pumping, Mixing, Diffusing, Reacting, and Separating Fluids

(71) Applicant: Gideon Samid, Rockville, MD (US)

(72) Inventor: Gideon Samid, Rockville, MD (US)

(21) Appl. No.: 19/644,936

(22) Filed: Apr. 10, 2026

Related U.S. Application Data
(63) Continuation-in-part of application No. 18/787,413, filed on Jul. 29, 2024, now Pat. No. 12,663,004.

(51) Int. Cl. B01F 31/441; B01D 33/01; B01F 23/43; B01J 19/18; F04B 19/04

(52) U.S. Cl. CPC B01F 31/441; B01D 33/0158; B01F 23/43; B01J 19/1806; B01J 19/1812; F04B 19/04; B01F 2215/0409

(57) ABSTRACT

A construction and a methodology for handling common fluid unit operations: pumping, mixing, separating, reacting, diffusing, storing. A single universal design is parametrized per each unit operation. The construction is modular, basic unit operations are fit together into concise, efficient, manufacturing process. Designed to fit into AI-guided process control.

This application is also a continuation in part of U.S. patent application Ser. No. 18/241,973 filed Sep. 4, 2023. This application is also a continuation in part of U.S. patent application Ser. No. 17/504,486. filed 2021 Oct. 18, and also a continuation in part of U.S. patent application Ser. No. 17/063,523 filed Oct. 5, 2020. This application is also a continuation in part of U.S. patent application Ser. No. 15/997,662 filed Jun. 4, 2018.

### CROSS REFERENCE TO RELATED PROVISIONAL APPLICATIONS (CLAIMED BY THE CONTINUED APPLICATIONS)

Provisional Application 62580111 filed Nov. 1, 2017 Referenced in the continued Application 15997662, and Provisional Application 63034401 filed Jun. 4, 2020, Provisional Application 63/051,652 filed Jul. 14, 2020, Provisional Application 63/005,062 filed Apr. 3, 2020, Provisional Application 62/963,855, filed Jan. 21, 2020, Provisional Application 62/931,807 filed Nov. 7, 2019, Provisional Application 62/926,560 filed Oct. 27, 2019, Provisional Application 63/140,006, filed Jan. 21, 2021.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

The continued application Ser. No. 18/787,413 introduced the multi-mode piston as a multi-application construction based on the concept of quantum fluid operation introduced in continued application Ser. No. 17/504,486 where instead of continuous chemical processing, a sequence of well-defined quanta of fluid are being treated one by one. This application further develops the multi-mode piston as an element in a universal construction aimed at re-thinking chemical engineering to taking advantage of the emerging AI-guided process control.

Summary: A battery of coordinated rotating pistons drilled with fluid-passage, dynamically opened and closed holes, combine into a universal fluid operating system (FOS) for storing, pumping, mixing, diffusing, reacting and separating liquids and gases alike.

While fluid dynamics in particular and transport phenomena in general are well described mathematically, in practice a great deal of experimental data is used. This creates a fertile ground for artificial intelligence, AI, to carry out and control fluid operation. AI operates best over a universal platform with many real time sensors and many control points. It is therefore of advantage to use a universal fluid handling apparatus. Proposing a platform of coordinated multi-mode pistons that move laterally, rotate around their axis, and are featured with assorted holes that can be of desired state: fully closed, fully open, or partially open. As these hole-drilled pistons move laterally, rotate, and the state of their holes changes they can conduct storing, pumping, mixing, reacting, phase changing and separating a combination of fluids, and efficiently serve industrial processing objectives.

### 0. BRIEF EXPLANATION OF DRAWINGS

FIG. 1 Four States Multi Mode Piston. This figure shows a piston constructed with two discs with holes in them. The discs rotate one relative to the other. Disc 1 is shown with three sets of holes. Each set comprising 3 holes on same axis. One set is fit for neutral flow of liquid through it. The other set is optimized to enhance the effect of mixing of the flow through liquid, (adjusting the direction of the flow) and the third set is fit for discrimination between the chemical components in the passing through fluid. The three set are indicated by different shading. Disc 2 has a set of 6 neutral holes. The holes of Disc 2 may be congruent with the neutral set of Disc 1 and in that case the fluid passes in a neutral manner through the piston. When Disc 2 is positioned relative to Disc 1 such that its holes overlap the mixing set on Disc 1, then the passing fluid gets efficiently mixed. If Disc 2 is positioned such that its holes are overlapping the discriminating set of Disc 1 then the flow will experience discrimination of its components. Disc 2 may be positioned relative to Disc 1 in a way that no holes of one disc will overlap holes on the other disc, and in that case the piston will block any flow through it.

FIG. 2 Rotating Piston—Cogwheel Basis This figure shows a replaceable rotating disc that fits in a cogwheel pattern into a piston frame. It is easy to replace the inner disc to feature different array of holes, and do so without replacing the piston framework that is possibly hooked to a motorist function to get it to rotate as well as to move laterally.

FIG. 3 In tube pump This figure shows a flexible tube in which a flexible capsule is fitted. In this capsule a multi mode piston is moving back and forth according to the pumping protocol: holes are blocked one way and open the return way. This allows one to hide the pump inside the carrying fluid line. For example, the tube may be a big blood vessel, the capsule is a stent like the ones put against a blocked artery. And the moving small MMP inside is taking its share in the effort to pump the blood through the body.

FIG. 4 In Pipe Pump This figure is similar to FIG. 3 only that it depicts a non flexible pipeline, part of which serves as the capsule. In this case there are three MM pistons inside the pipeline: a, b, c. Pistons a and b serve as the edge of the capsule and piston c does the pumping work by moving back and forth between pistons b and c. In one direction piston c is totally open and in the reverse direction it is totally closed. Pistons a and b don't have to remain motionless. They can be dynamic.

FIG. 5 Multi Mode Apparatus engulfed with two capacity tanks: This figure depicts an MMP capsule containing a single piston and to pipe connections terminating with capacitor—a fluid container. These two capacitors will allow the MMP unit to operate at an effective flow rate which is different from the flow upstream and downstream. The variance will be absorbed by the volumes of the two capacitors.

FIG. 6 MMP with capacitors. This figure depicts an MMP platform comprising three capsules connected via capacitors and extended to capacitors, allowing the three capsule units to operate in different rate. The volume of fluid in the capacitors will change to accommodate the rate difference.

FIG. 7 MMP Capacitor Based Platform. This figure shows an MMP capsule unit fed from two capacitor containers which are each fed from a respective different MMP capsule unit. Reading the fluid level in the downstream, the MMP capsule control unit directs control of the two feeding capsules to optimize the process dynamics.

FIG. 8 Three Pistons Capsule Mode Platform—Split Mode: This figure shows an MMP capsule fed from a capacitor tank and feeding two downstream MMP units directly. The split units each feeds a respective capacitor tank. Proper valves are shown. In particular, the two valves leading to the split units, deciding each round to which unit the pre-split unit feeds.

FIG. 9 Split Capsule MMP. This figure shows a direct contact split configuration where a feeding MMP capsule unit of volume V₁, where the operative cycle lasts T₁ time, and the piston rotates at an angular momentum w₁. The right edge of the capsule feeds per choice to either the unit depicted as upper of volume V₂, of processing time T₂, and with rotational angular speed of w₂, or to the unit depicted as lower of volume V₃, processing time T₃, and rotational angular speed of w₃

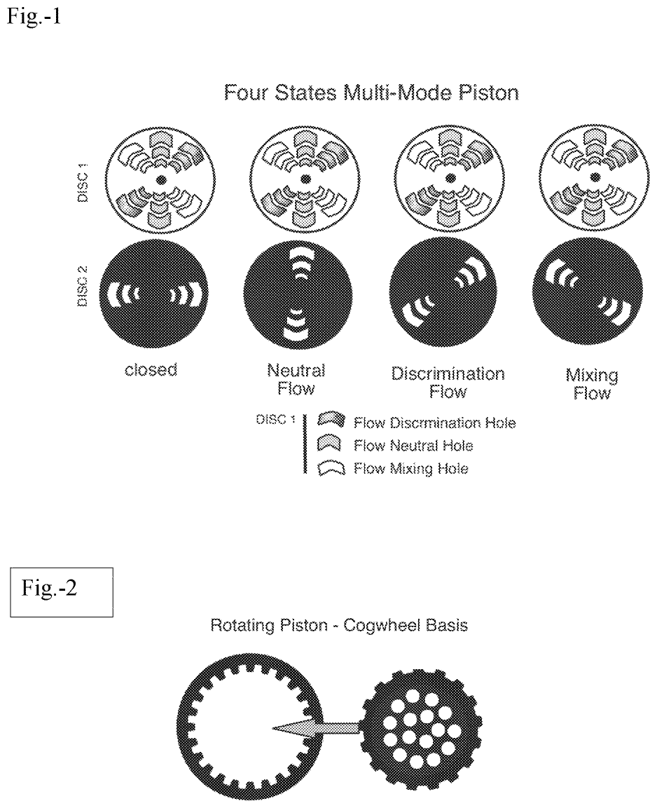

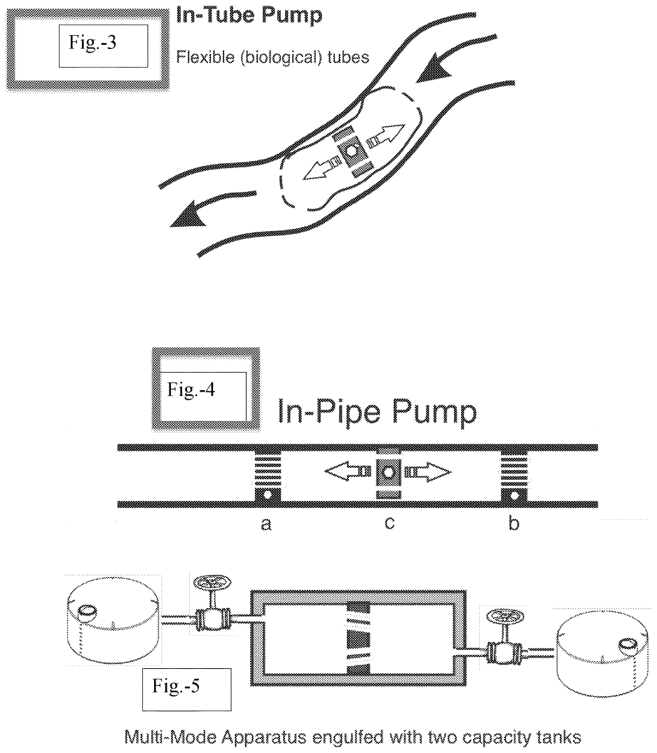

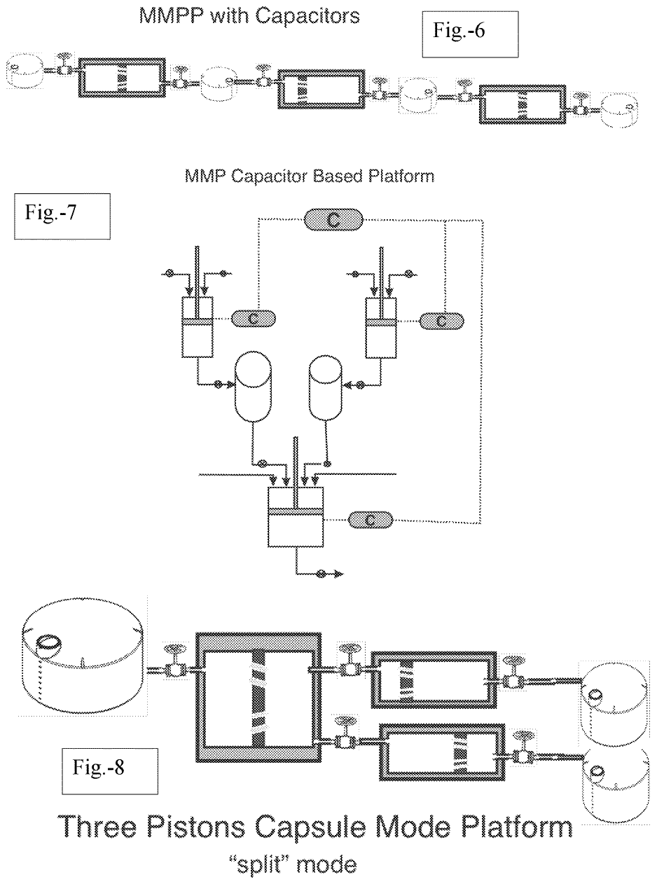

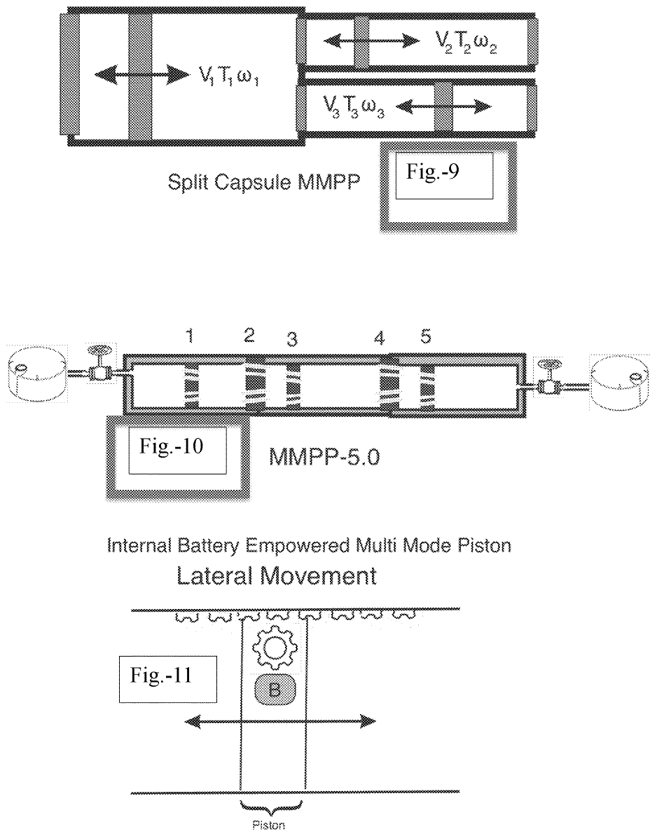

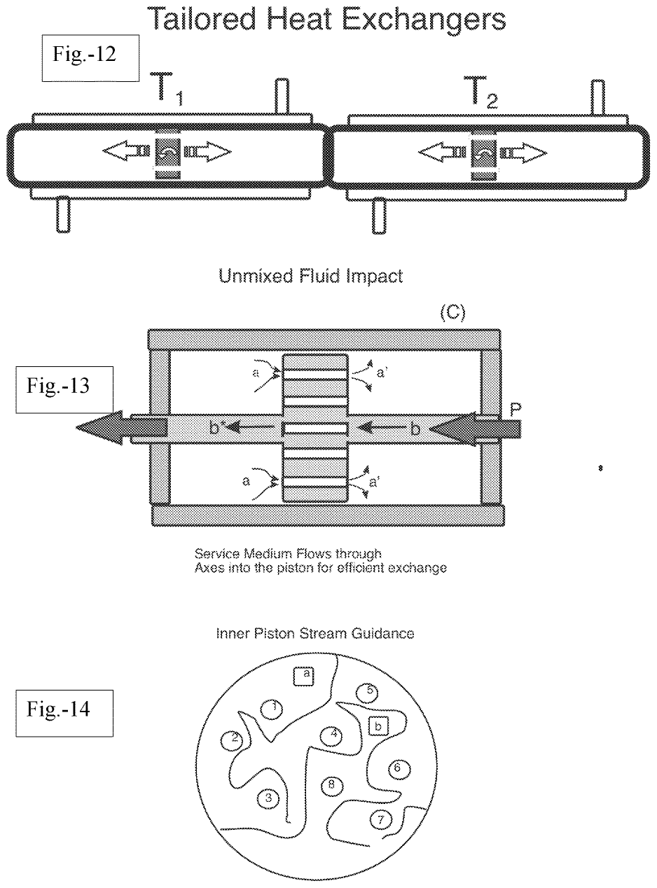

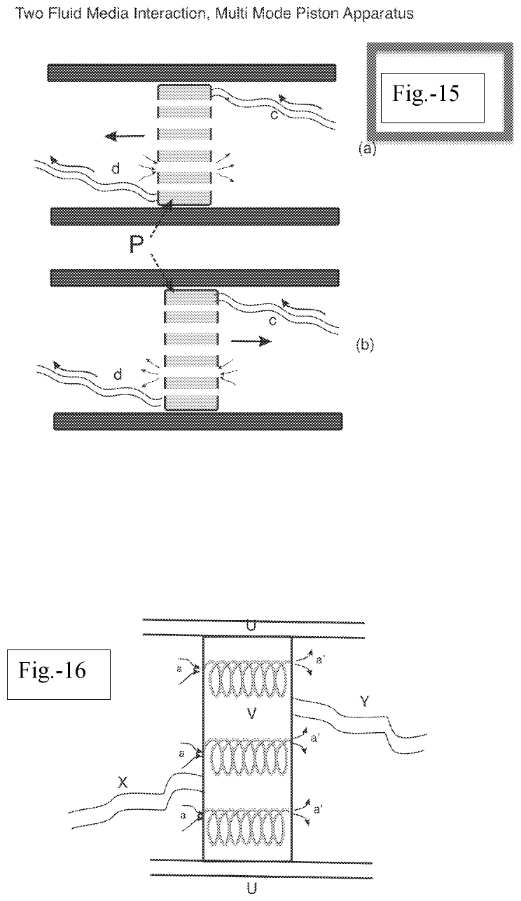

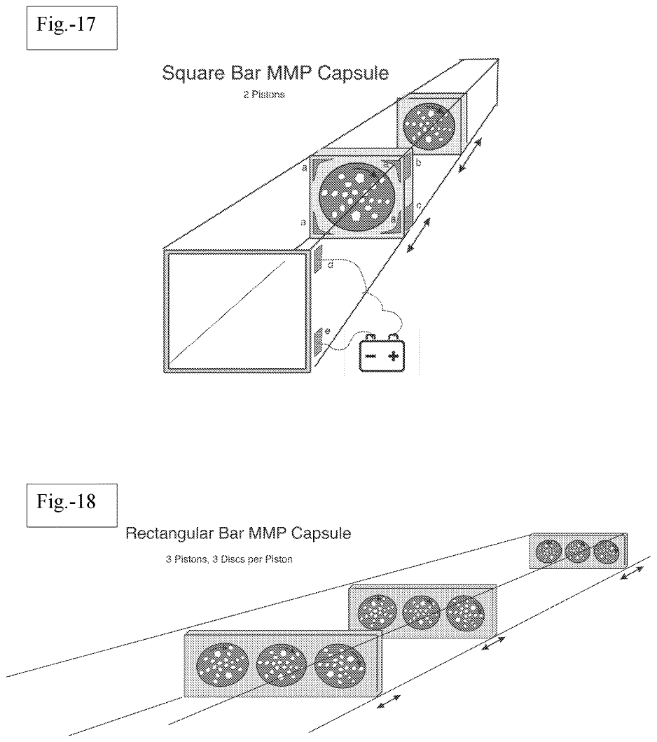

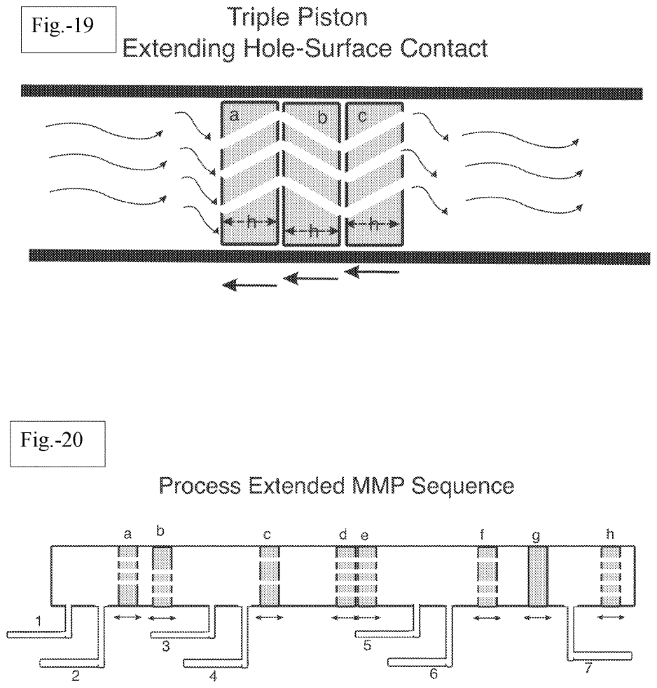

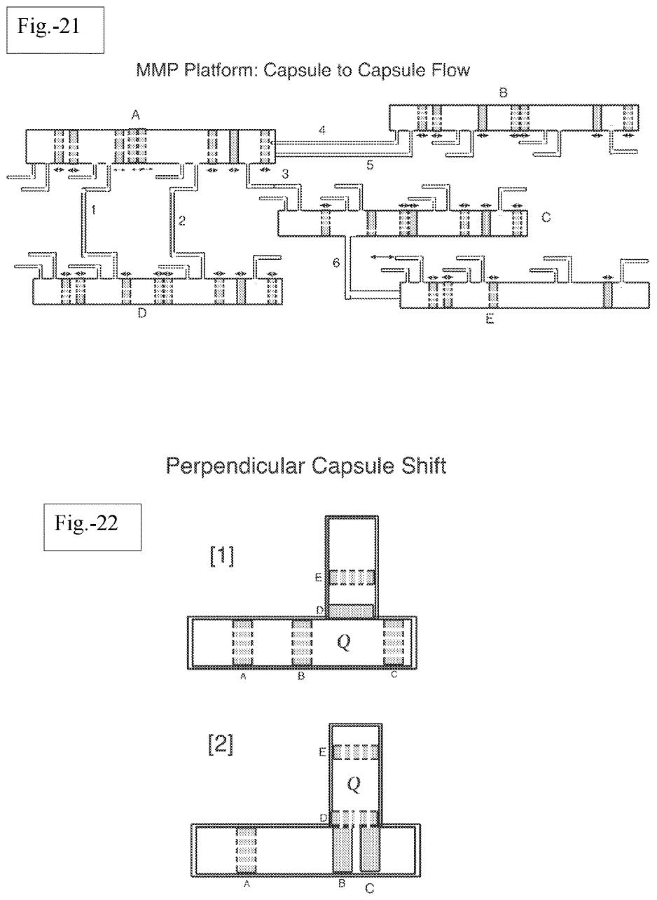

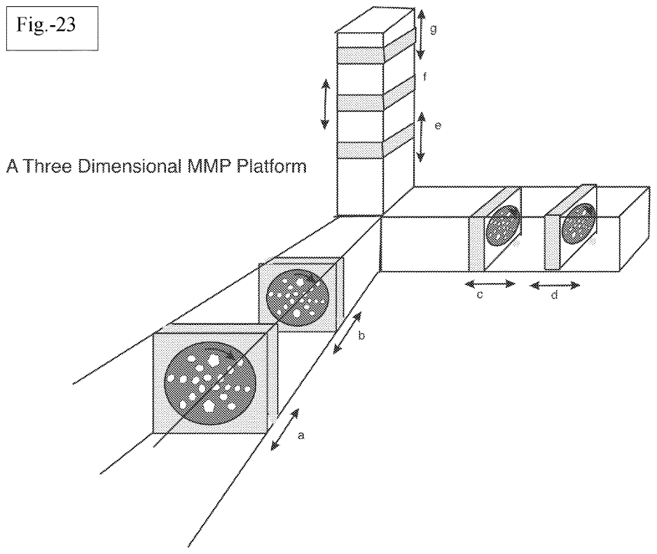

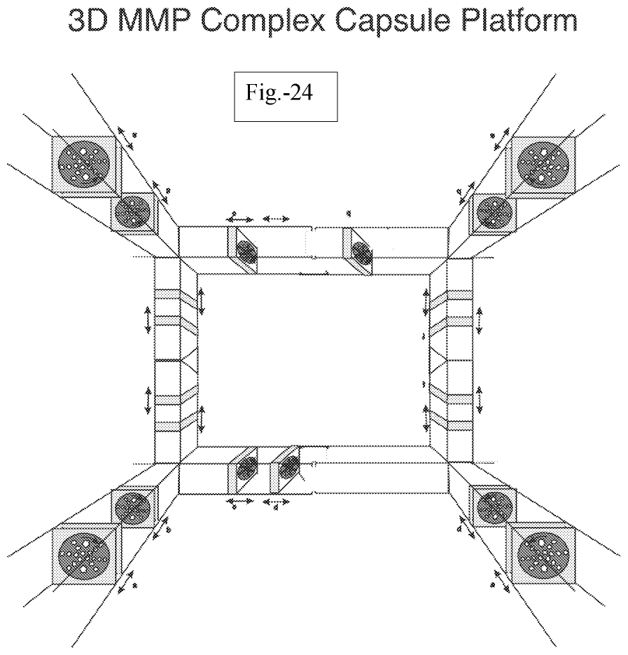

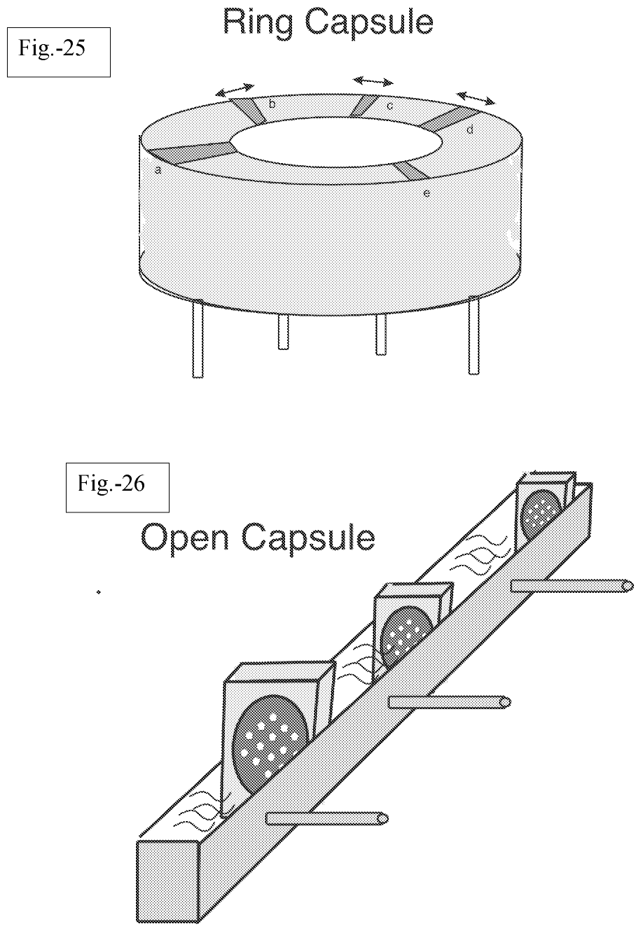

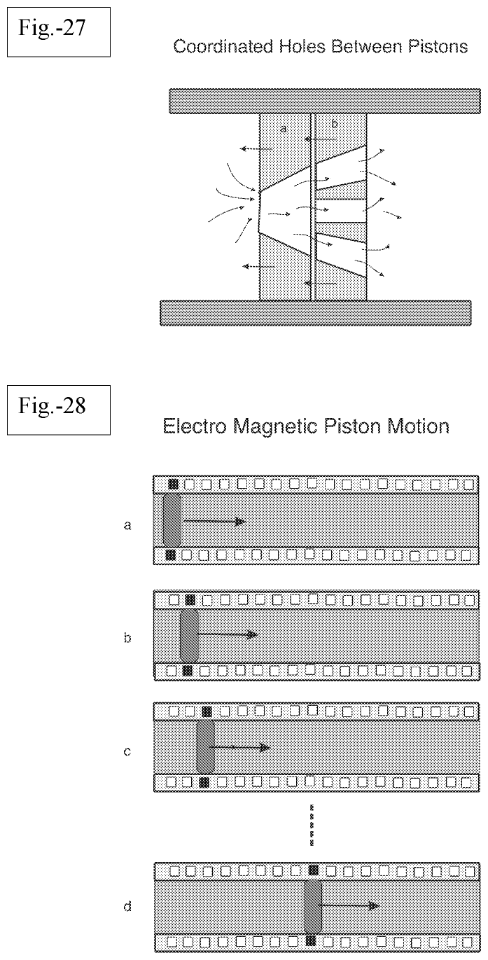

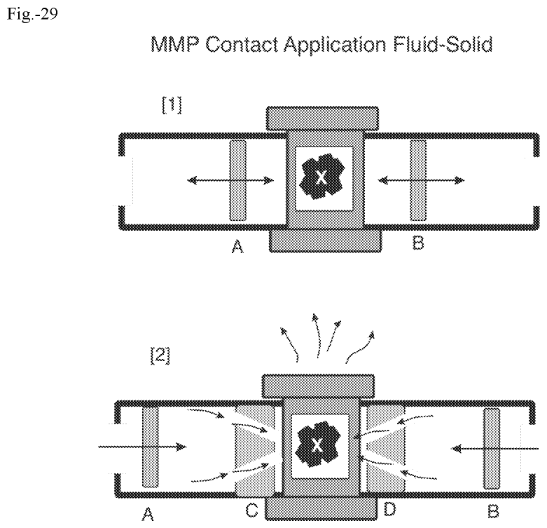

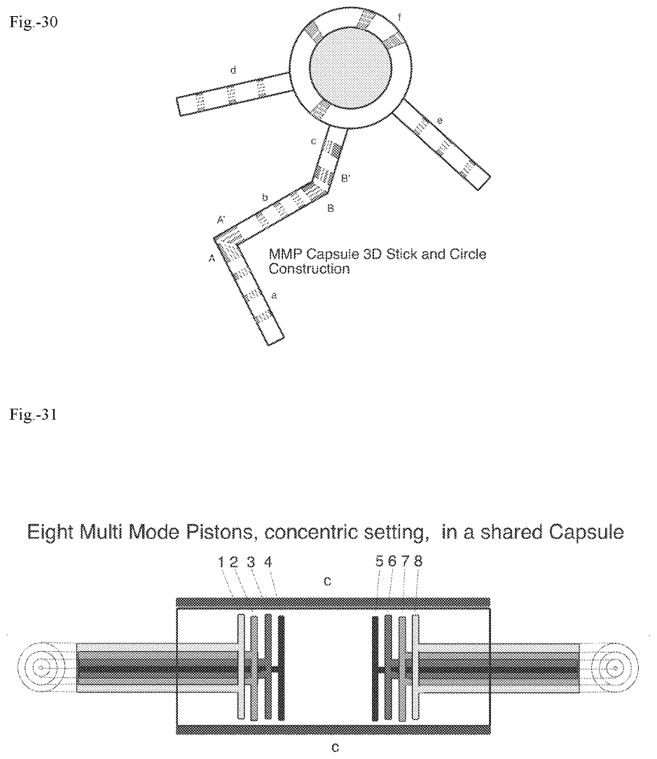

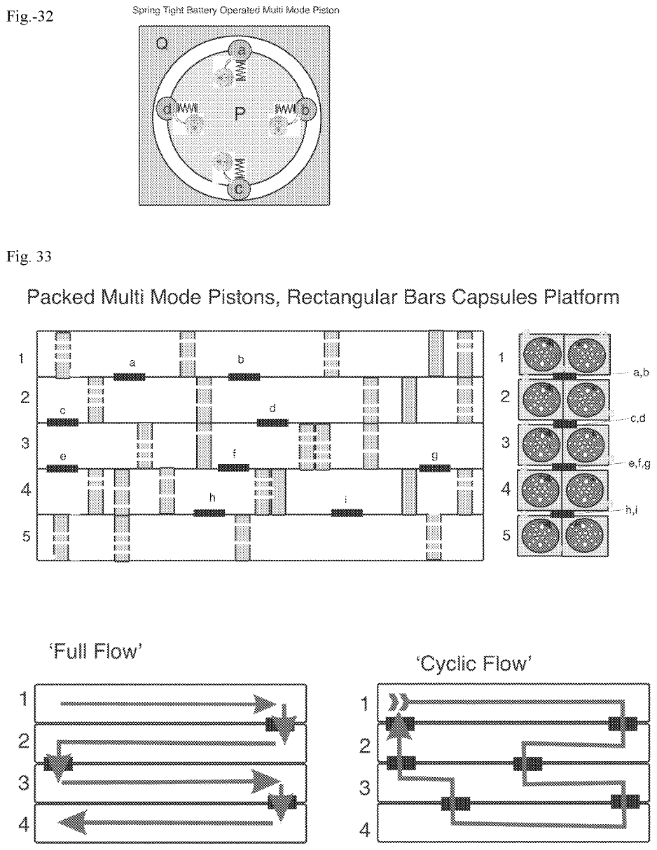

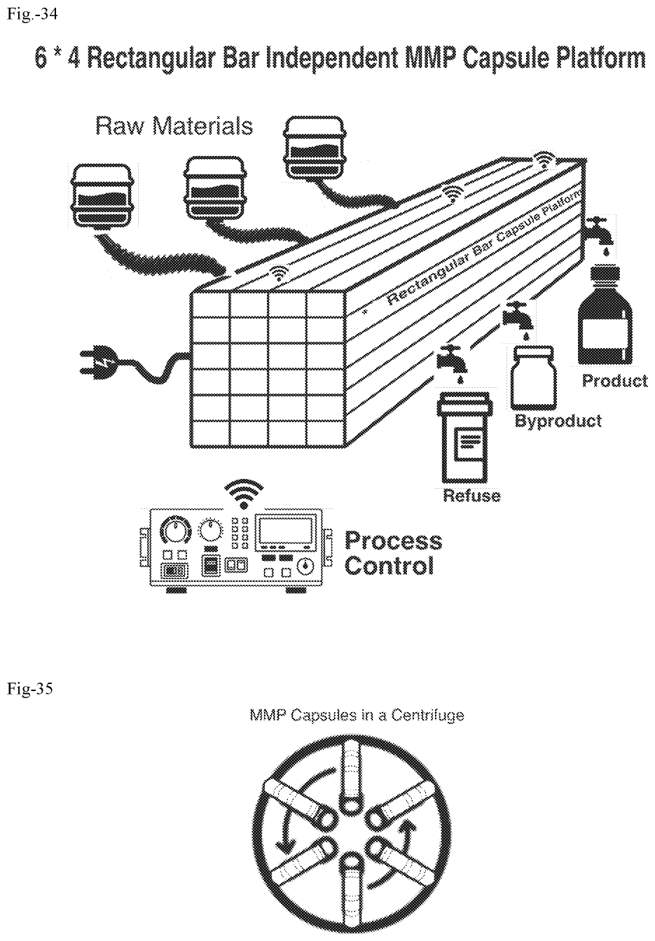

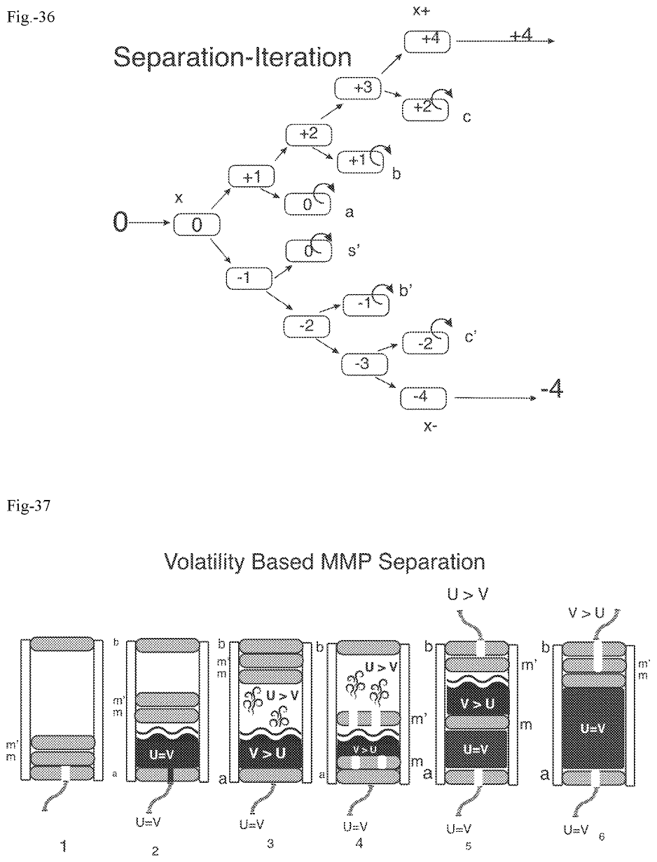

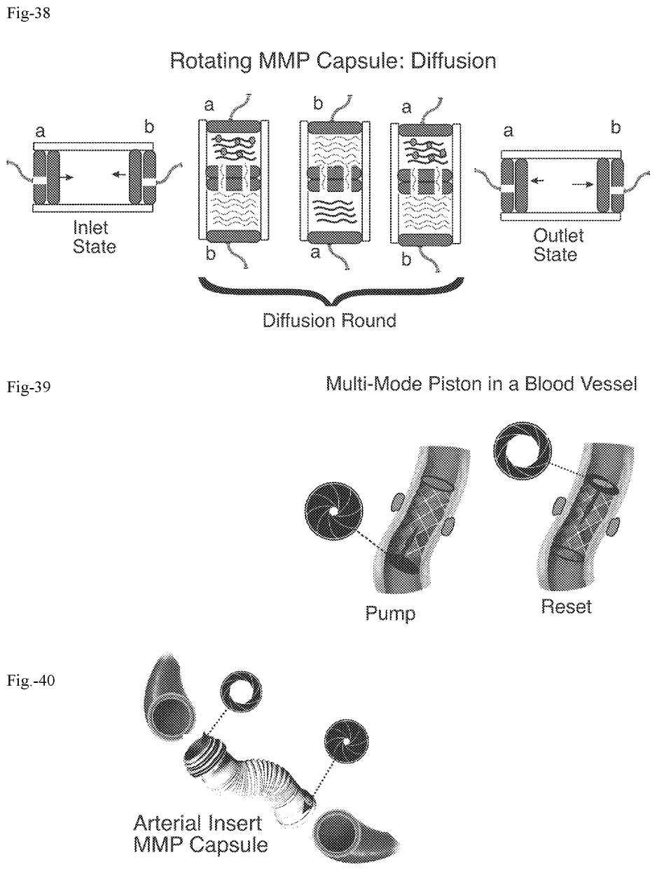

The three angular speeds wᵢ for i=1, 2, 3 are not related and can vary independently.

In the case where the piston in the feeding unit is pushing its quantum of fluid to both split capsule unit in parallel then because there is no capacitor tank between them, it must be that:

$${T}_{1} = {T}_{2} = {T}_{3}$$

$$and$$

$${V}_{1} = {V}_{2} + {V}_{3}$$

If the design is such that the feeding unit alternates between the two downstream MMP capsule units then the requirements are:

$${T}_{2} = {T}_{3} = 2 * {T}_{1}$$

$$and$$

$${V}_{1} = {V}_{2} = {V}_{3}$$

For any other process sequence the relationships between volumes and processing time will have to be adjusted.

FIG. 10 MMPP-5.0. This figure shows a capsule featuring 5 pistons. The capsule is connected to a capacitor on either end.

FIG. 11 Internal Battery Empowered Multi-Mode Piston. This figure depicts a capsule (two horizontal parallel lines), with a piston inside. The piston has a built in battery B that operates on a small cogwheel, that is designed to crawl over ‘teeth’ built into the internal surface of the capsule. This implements a piston that moves back and forth inside the capsule using a piston built in power, and friction bearing cogwheel like structure.

FIG. 12 Tailored Heat Exchangers: This figure shows two connected MMP capsules, each capsule is wrapped with a heat exchanger that keeps the fluid in each capsule at a different temperature. The shown temperatures T₁ and T₂ may be very different one from the other. Similarly any number of capsules, each adjusted to an arbitrary temperature is possible. Each capsule can be equipped with a thermometer to measure the temperature inside, The quantum of fluid in each capsule may be mixed by moving the piston inside in an open state, as many times as desired until the thermometer indicates the desired temperature. The second capsule will have to wait until the temperature in the first capsule reaches the desired state. That is because the two shown capsules are not separated by a capacitor but are directly connected.

FIG. 13 Unmixed Fluid Impact. This figure shows an MMP capsule where the piston is filled with an inside-piston flowing fluid that touches the holes of the pistons from the piston inner side, while the capsule fluid touches the opposite (hole side) surface of the piston holes. This creates a situation (common in heat exchangers) where two fluids, the capsule fluid and the piston fluid meet each other while they each flow in their own track, and the walls of the piston holes separate between them so they don't mix. The figures show the fluid-filled piston is moving right to left, thereby forcing the capsule fluid to flow through the piston open holes, showing pre-hole flow a emerging as post-hole flow a′. At the same time some pressure P applied to the pipeline that connects to the piston is pushing the piston fluid in the opposite direction. Pre piston fluid b emerges from the piston as flow b′.

FIG. 14 Inner Piston Stream Guidance. This figure shows a flow guidance design inside the piston to guide the piston fluid as it flows around the piston holes from the opposite side of the capsule fluid. The piston fluid enters through opening a, is first encountering hole 1. A “fence” inside the piston guides the entering piston fluid to run around hole 2 next and from there to hole 4, 5, 6, 7, and 8 before the piston fluid runs into point b where it gets out of the piston to the conduit that removes the piston contents.

FIG. 15 Two Fluid Media Interaction, Multi Mode Piston Apparatus. This figure shows how the capsule fluid and the piston fluid are meeting each other across the surface of the holes in the piston. The figure shows the capsule represented by two horizontal dark parallel walls. Between these walls a piston is shown in an open state. In the upper (a) section the piston is shown moving right to left. This forces the capsule fluid to flow left to right. The piston is connected to a flexible input line (c) that feeds the piston fluid into the piston. The piston fluid then leaves the piston through flexible line d. Because lines (c) and (d) are flexible, they remain as viable inlet and outlets for the piston fluid as the piston moves back and forth in the capsule. The piston P is then shown moving backwards from left to right, causing the capsula fluid to reverse course, while the piston fluid maintains course.

FIG. 16: Spiraling Piston's Holes. This figures shows piston holes which are spiraling in order to create a long path through them and while the capsule fluid flows through these spirals, it spends more time being impacted by the fluid in the pistons through the walls of the holes. The figure show fluid arrows a sucked in to the spiral holes on account of the piston moving right to left. The fluid comes out on the other side of the piston marked a′. The piston fluid is connected to flexible tube X through one side and to flexible tube Y through the other side of the piston V, which is moving in capsule U.

FIG. 17: Square Bar MMP Capsule. This figure shows a square shaped bar capsule with two square pistons moving inside. The square pistons have rotating discs with holes inside. The corners of the square pistons may house batteries (a) to power up the rotation and the changing of open/closed status of the holes. These piston-bound batteries are being charged through two charging ports (b,c) on the piston. When the piston is positioned in its ‘charging spot’, these charging ports (b,c) are matched with capsule-installed charging ports (d,e) which are fed from an external power source. The pistons travel to the charging position, get charged, and then move around. The pistons may be wirelessly controlled from a central controller.

FIG. 18 Rectangular Bar MMP Capsule. This figure shows a rectangular capsule with three pistons inside. Each piston features three discs, each disc is rotatable inside the piston and features a set of holes that can be independently opened or closed. The rotating discs all rotate independently and their holes are in open/closed state independently of each other. The three pistons can move laterally in the rectangular bar capsule. Every spot on the capsule may be turned into an inlet or outlet. Similar rectangular-bar capsules can be easily packed into a tight structure. fluid can flow directly from one rectangular-bar capsule to another, or through a capacitor. The dimensions of the capsule are arbitrary so is the count of pistons and their design.

FIG. 19 Triple Piston—Extending Hole-Surface Contact. This figure shows three pistons in a capsule. The pistons are abreast each other, touching, and all move from right to left. They are rotated one relative to the other such that they create fluid passage ways across the three of them, and each passage way is diagonal so as to create a long route of fluid moving through the matched holes in the pistons. The pistons in this figure happen to be of equal width, h, but the width can vary. Instead of three touching pistons that could have been four, five or more, to adjust the length of the passage of the fluid from entering the most left wise piston and until leaving the most right wise one.

FIG. 20 Process Extended MMP Sequence. This figure shows one long MMP capsule that contains 8 pistons a,b,c,d,e,f,g,h each can move back and forth inside the capsule. Each piston at any moment can be in its own rotational stage and have all its holes either open or close—all independently. The capsule is shown to have pipe connections with the outside: 1, 2, 3, 4, 5, 6, 7. Each such connection may be set to be an inlet or an outlet of fluid. Such a loaded contraption is very flexible to be used for a variety of process requirements, and it a fertile ground for AI optimization.

FIG. 21 MMP Platform: Capsule to Capsule Flow. This figure shows 5 MMP capsules A, B, C, D, and E connected directly through a web of pipelines, 1, 2, 3, 4, 5, 6, . . . Each capsule has its own number of pistons, which move independently and rotate independently and open-close their fluid passage independently, creating a very large degree of freedom to design a flowing chemical process with multiple reaction, syntheses, separations, etc.

FIG. 22 Perpendicular Capsule Shift. This figure shows two rectangular bar capsules matched perpendicular one toward the other. The horizontal capsule features pistons A, B and C, and the vertical capsule contains pistons D, and E. In the upper part of the figure, state [1] the figure shows an amount of fluid Q captured between pistons B and C in the horizontal capsule. The objective is to move this quantum of fluid, Q, to the vertical capsule. To do this one will hold pistons B and C in a ‘closed’ position while holding pistons A, D, E in open position. Then one will shift pistons B and C towards each other. This motion will force quantum of fluid Q to escape through the open piston D to the vertical capsule to occupy the volume between piston D and piston E. Since piston E is open it will allow the fluid previously between E and D to be pushed beyond piston E. Also fluid left of piston A will flow to the right of piston A to occupy the space generated from moving piston B from left to right. When Q is fully pushed to the vertical capsule, piston D may be shifted to close and thereby the quantum of fluid Q previously sitting in the vertical capsule is now held in the vertical capsule.

FIG. 23: A Three Dimensional MMP Platform. This figure shows three rectangle bar capsules matched in three dimensional mutual perpendicular configuration, with ‘doors’ between them (open/close areas). All the capsules have pistons. Fluid can pass along any capsule, and from one capsule to the other with proper coordinated setting of the involved pistons. Such perpendicular configuration allows for a rich variety of architectural variety.

FIG. 24. 3D MMP Complex Capsule Platform. This figure shows eight MMP capsules constructed into a three dimensional complex that may be designed to serve an involved process.

Each capsule has pistons. Quantum of fluid can be moved freely inside the capsules and between capsules.

FIG. 25 Ring Capsule. This figure shows a ring shaped capsule. Five pistons are set in the ring, a,b,c,d, and e. They each can move in both directions in the ring. A few pipe connection are fitted at the bottom of the ring capsule allowing for fluid to be bet let in and let out. The ring may allow for circular action or for one directional process including a variety of unit operations.

FIG. 26: Open Capsule. This figure allows for an open capsule to be fitted with three piston and three sideways inlet/outlets. Motions of pistons in an open capsule may be more guarded to prevent spill over.

FIG. 27: Coordinated Holes Between Pistons. This figure shows two pistons a and b put abreast each other. The pistons move from left to right forcing the fluid to flow from right to left. The fluid is forced into a widening shaped hole in piston a from where it is guided to one of three passage way holes in piston b, creating three jets of fluid carrying momentum in the direction of respective jet. This figure demonstrates the ability to control flow pattern by properly matching rotation and close/open states within connected pistons.

FIG. 28 Electro Magnetic Piston Motion. This figure shows a piston moved around by changing the location of a magnetic pull. A series of rings is embedded in the capsule. Electronic circuitry switches electric current (and magnetic pull) from ring to ring. As this switch occurs the magnetic sensitive piston is moving towards the pulling ring. The rate of switching rings for electrical current determines the speed of the piston in the capsule. The direction of movement and speed are totally determined through managing electrical activity in the rings inside the capsule. The figure shows the state of a piston in positions a, b, c, and d.

FIG. 29 MMP Contact Application Fluid-Solid. This figure shows two ways to use MMP to achieve an intense contact between a streaming fluid and a lump of solid. The purpose may be heat exchange, superficial reaction, catalysis etc. In the upper part [1] two pistons A and B are moving in the same direction and then switching, forcing the capsule fluid between them to flow over and around a lump of solid marked as X. In the lower part of the figure, [2], two pistons A and B in closed state are moving towards each other and thereby forcing fluid between them to flow through two stationary pistons C and D where the holes are oriented to generate flow lines that impact the lump X in an advantageous way, as seen in the slated holes in C and D. The fluid escapes upwardly. There are many other routines that will create a desired flow over of the capsule fluid over a lump of solid matter X.

FIG. 30: MMP Capsule 3D Stick and Circle Construction. This figure shows an MMP platform comprised of one ring capsule connected to two ‘straight bar’ capsule, and to one “three bars” capsule. Each part of the capsule contains multi mode pistons. Pistons A and A′ are configured to match on contact despite each being fitted into different capsules. Same for piston B and B′.

FIG. 31: Eight Multi-Mode Pistons, concentric setting, in a shared capsule. This figure shows an MMP sequence comprising eight pistons (1,2,3,4, 5, 6, 7, 8) sharing a capsule (c). The pistons are controlled through sets of concentric rods where each rod positions its piston between the piston before and the piston after. In This setting the pistons are controlled from the outside.

FIG. 32. Spring Tight Battery Operated Multi-Mode Piston. This figure shows a piston with four round bearings or wheels that are fitted with a wound spring that keeps the piston tightly attached to the capsule, while an electric motor impacts motion to each bearing or cylinder to keep the piston moving back and forth along the capsule, and also impacts a rotational motion for round bearings.

FIG. 33: Packed Multi-Mode Pistons, Rectangular Bars Capsules Platform. This figure shows five rectangular bar MMP capsules (1,2,3,4, 5) combined into an integrated platform. The rectangular bar platforms are stacked one upon the other. Capsule 1 and 2 shown with 5 pistons each, have two fluid connection ports (FCP), a and b. Through each of these FCPs fluid can flow either from capsule 1 to 2 or vice versa. The FCP are centrally controlled as to their status at any moment, open or closed. Capsule 2 is stacked upon rectangular bar capsule 3 and shared two FCP's with it (c, d). Capsule 3 is stacked upon rectangular bar capsule 4, with which it shares three FCPs (e, f, g), and Capsule 4 is stacked upon rectangular bar capsule 5 with which it shares two FCP's (h,i). This stacking allows for fluid to flow from any capsule to any other capsule, and throughout the length of each capsule. The side view shown on the right of the figure depicts two rotating discs for each piston on all the capsules, and it also depicts the FCPs. The lower part of the figure shows two possible flow patterns over a platform comprising four attached MMP capsules. in the ‘Full flow’ a quantum of fluid is pushed from right to left on capsule 1, then pushed down to capsule 2 on its right side and from there pushed all the way to the left side where it is pushed down through an FCP to capsule 3, moved through the length of the capsule to its right side where another FCP leads its passage to capsule 4 from where the quantum of fluid is moved to the left side of the capsule. This way a quantum of fluid was lead to travel through the full length of the 4-capsules platform. The movement of the quantum is executed through a coordinated control of the multi mode pistons in every capsule. With a proper motion and a proper switch between open and closed states the pistons can move any quantum of fluid anywhere in the platform. Also on the bottom side of the figure, a ‘cyclic flow’, in which a quantum of fluid traverses from the left side of capsule 1 through all the capsule in the platform until it is being returned to the location where it started. The quantum of fluid is pushed from left to right on capsule 1, then pushed down through an FCP to capsule 2 right side. It is being pushed then to the middle of capsule 2 where it is being pushed to capsule 3 and there all the way to the right, pushed down to capsule 4, left on capsule 4 then close to its left side, it goes up back to capsule 3, pushed left on capsule 3, up to capsule 2 via an FCP and up directly to its original location on the left side of capsule 1.

FIG. 34: 6*4 Rectangular Bar Independent MMP Capsule Platform: This figure shows a full chemical process line from raw materials to product, byproduct and refuse—all executed and carried out in a packed rectangular bar MMP capsule platform. The raw materials are admitted at designated points into the platform and the products, the by products and the refuse are flowing out from designated ports. The platform is operated through the motions and change of state of all its pistons as they are fitted to each of the capsules of the platform. The pistons are moved around with electric power. The status of the fluid in various parts of the platform is sensed and recorded by sensors and recorders which communicate their findings to a central control station which in turn issues commands to the operating pistons—also wirelessly.

FIG. 35 MMP Capsule in a Centrifuge: This figure shows six capsules fitted into a centrifuge which separate ingredients per their weight. As the fluid far from the center becomes richer with the heavier product, it can be separated by a simple separation procedure applied to the pistons in each of the fast rotating capsules. Separation happens through moving of pistons and adjusting their open/close status. This can be done while fast rotating in the centrifuge. When the centrifuge is stopped, the heavier portion of the MMP fluid is separated from the rest.

The figure also shows wireless communication between a control center of the platform and elements inside the platform. Wireless recorders and sensors tell the control center the state of the fluid inside, and the control center sends position and movements order to the pistons in the platform, and to the FCPs.

FIG. 36 Separation-Iteration: This figure shows the iteration process applied to successive MMP separation rounds. The pre-separated quantum of fluid, Q is put into capsule X. It includes a mix of two ingredients A and B. In it undergoes a separation process resulting in filling half a Q to another capsule marked +1 indicating that it is richer with ingredient A, and the other half of the Q is routed into a capsule marked −1 indicating fluid richer with ingredient B. This separation happens twice so that the capsules marked +1 and −1 off capsule X are each full with a Q amount of fluid. The “+1” capsule undergoes a similar separation process resulting in half a Q routed to capsule marked +2 and the other half routed to capsule marked “0” (a). Capsule (a) as indicated by the circular arrow, circles back its contents to the starting capsule (x) of the same A-B balance. Capsule +2 when full undergoes a separation round, resulting in half Q routed to capsule marked +3 and half Q routed to capsule marked +1 (b). The (b) content is routed to the previous +1 capsule, and the +3 capsules, after more rounds to fill it up is undergoing its own separation round, resulting in dividing its contents to one capsule marked +4 (x+) and another capsule marked +2 (c). The contents of c is routed to the previous capsule marked +2, and the contents of the +4 capsule (x+) is taken out as the satisfactory degree of A-B separation. A symmetric process is taking place relative to the capsule marked −1 off of capsule x, only in favor of B not A. In the B-side of the iteration capsule a′ with content 0 is re-routed to capsule x, capsules (b′) and (c′) are routed to the previous capsules of the same degree of separation. In summary the pre-separated fluid routed into capsule x ends up emerging from this iteration system through highly enriched A, from capsule x+, and through highly enriched B from capsule x′. The 15 capsules shown in the figure may be part of a platform with intervening capacitors, or a direct setup. The capsules may be constructed as a 2D or 3D constellation as packed bar capsules or otherwise.

FIG. 37 Volatility Based MMP Separation. This figures shows steps executed by a vertical MMP capsule to achieve separation based on volatility differences. Step 1 shows the capsule with piston a at the bottom, piston b at the top, and pistons m and m′ both at the bottom, all pistons in closed state. Step 2 in the figure shows an a-side inlet of a solution with a balanced blend of elements U and V, U=V, (which may comprise several chemical entities each), where the U part is more volatile than the V part of the blend. The blend is in liquid form and is sucked in by opening at least one hole in piston a, and by lifting pistons m and m′ both in a closed state. Pistons m and m′ stop at mid way up the sleeve (the capsule). Then step 3 is introduced: pistons m and m′ still in a closed state, are further lifted to the top of the sleeve, while piston a reverts to closed state. This step then creates vacuum above the liquid level in step 2. This reduction of atmospheric pressure causes parts of the liquid in the sleeve to turn into gas that fills the volume from the top of the liquid phase to the bottom side of piston m. This gaseous phase is richer with the more volatile elements of the blend, U, namely the gas is in U >V state, and henceforth the remaining liquid phase is V >U state. Thereby a separation occurred between the liquid and the gaseous phase. What is left now is to separate the gas from the liquid phase. To that end the procedure proceeds to step 4: pistons m and m′ are switching to open state and move down the capsule. Piston m moves all the way to the bottom, allowing both the liquid and the gas to flow through its open holes, and piston m′ is moving down to the surface of the liquid. At this position piston m′ separates between the V-richer part of the Q (quantum of fluid in the capsule) in liquid phase and the U-richer part of Q in the gaseous phase. Next comes step (v) in which both pistons m and m′ switch to closed position, while pistons a and b switch to open state such that new U=V balanced fluid can fill the capsule through piston a, and the two separated parts of the processed Q can each flow from the capsule to a dedicated receptacle through one or more holes in piston b. Once all the four pistons switch their open/close states, both pistons m and m′ move upward. Piston m′ is pushing the gaseous phase part of Q through piston b to a U-rich receptacle Gu, while piston m is pushing up the liquid part of the Q (rich in V), to occupy the capsule from a mid point on the capsule to the top of the capsule (where pistons m and b are placed). While rising piston m suck in fresh balanced liquid (U=V) through piston a. Step (v) comes to its end when all the gaseous material, rich with U, is routed to a U-receptacle, Gu. When this happens, the procedure proceeds to step (vi) where piston m′ switches to open state, and piston m, still in closed state, is pushing the liquid above it to a V-receptacle that collects the V-rich (V >U) liquid through an open hole to a V-receptacle, Gᵥ, dedicated to the V-rich fluid. As piston m is moving upwards it sucks more feed fluid into the capsule, and when m reaches the top of the capsule, the entire capsule is filled with another quantum of U-V balanced (U=V) fluid, ready for another round of volatility based separation.

FIG. 38: Rotating MMP Capsule: Diffusion. This figure depicts the use of an MMP for enacting a diffusion operation between two immiscible liquids, where the liquids have notable difference in their specific weight. One desires the light liquid to rise as bubbles in the heavy liquid, with a specific dimension range for the bubbles, to ensure mass transfer through their shared surface, yet preventing thorough mixing resulting in froth and other undesirable outcomes. The idea being to let the light liquid to rise up to the volume above a mid section piston where the heavier liquid is placed, going through specially designed holes, ensuring the desired size bubbles. It is done by flipping the capsule so that the lighter liquid is at the bottom, and right away bubbles up through the heavy liquid above a midlevel piston, when the light and heavy liquid change places, the capsule is being flipped again, and then again, as many times as necessary before discharging the two mutually diffused liquids into dedicated receptacles. The procedure is shown beginning with the inlet state where the capsule is horizontal (not necessarily so). There are 4 pistons: a and b are the stationary edge pistons and two middle pistons. In step (i) the inner pistons are shifted to their respective edge, turn into ‘close’ state, and pistons a and b admit the two immiscible liquids that should undergo a diffusion process. The liquid is sucked into the capsule as the two middle pistons are moved towards each other. When done,
(ii) the capsule is flipped vertically with the light liquid at the bottom part, below the two middle pistons which are abreast of each other; the two middle pistons are turned into open state, allowing the light liquid below them to bubble up to replace the heavy liquid above by forming bubbles determined by the shape of the holes for the two middle pistons. When the two liquids exchanged location inside the capsule, comes forth step (iii) the capsule is flipped upside down, returning to the initial conditions, and the light liquid once again bubbles up to replace the heavier liquid on top the open two middle pistons. The capsule is flipped as many times as desired, the shape of the bubbles can be changed by changing the opening of the holes in the middle pistons. When done, (iv) the capsule is turned to horizontal states, the two mid pistons switch into closed state, and two edge pistons switch into open state, and the two mid pistons are moved each to its respective edge thereby pumping out two immiscible liquids to their respective container, and the capsule is ready to process another quantum Q of the two immiscible liquids. During the diffusion the capsule may be equipped with probes that indicate when the diffusion achieved its goal state.

FIG. 39: Multi Mode Piston in a blood vessel: This figure shows a blood vessel in which an MMP set up is installed. A stent like capsule structure keeps the vessel open to the motion of the piston. The piston moves back and forth inside the embedded capsule. The piston is built like a camera shutter allowing for quick switch from almost 100% open to almost 0% closed, and vice versa. In the pumping direction the piston is closed and moves the liquid forward. In the reset mode the piston is open, and slides back to its starting pumping position. The blood vessel is wrapped by a ‘power belt’ (grey markings) that supplies the power and the command to the moving piston. The piston command may be coordinated with other pumps throughout the body and with the dynamics of the patient's heart.

FIG. 40: Arterial Insert MMP Capsule: Alternative to in-artery MIP capsule solution, the supported artery is cut and a foreign capsule connects between the cuts, exercising coordinated pumping.

### 1.0 INTRODUCTION

A Universal Construction for Storing, Pumping, Mixing, Diffusing, Reacting, and Separating Fluids is based on a construction of several coordinated pistons which can each move back and forth along their axis, rotate around their axis, and dynamically change the open-closed state of several holes drilled into the piston's surface.

The surface of the holes may be constructed from some fluid impact material, and the piston may be filled with a special piston fluid. When a set of such multi-mode pistons is moved, rotated, and changes the state of its holes, it can carry out a large number of common chemical engineering unit operations. The state of the processed fluid can be monitored live, and the data can be used by AI powered controller to control the many degrees of freedom available in such an MMP (Multi Mode Piston) setting in order to optimize fluid handling over its many objectives.

The set of combined pistons operates within a fluid containing sleeve. A terminated sleeve is regarded as an MMP capsule, or simply capsule. The capsule captures a quantum of fluid and carries out certain operations on this quantum of fluid. An MMP capsule unit takes in one quantum at a time. This discrete mode can be fit into, interact, or replace the common continuous mode. Analysis:

Chemical engineering operates either in batch mode, or continuous mode, where small scale experimental work is done batch, and main stay industrial chemical production is in continuous flow. The latter preference was on account of simplicity and streamlined operation. In continuous mode changes take place at successive process stages while each stage is in a fixed state over time. The more uniform the feed for the process the more attractive is the continuous operation. However, where such uniformity is lacking then each ‘batch’ of input will require a different optimized processing, which requires a division of the input flow as a series of quantum of fluids, each treated optimally per the particular attributes of this quantum.

As the age of AI is upon us, and advanced technology allows real time measurements of physical and chemical parameters, there is a new opportunity to treat each quantum of fluid in the input stream as a case on its own, individually optimized.

1.1 Quantum Mode within a Continuous Flow

A continuous flow at a rate q* (kg/hr), can be interrupted by collecting from the stream an amount Q at fast speed of q** (kg/hr), then processing Q for a period of time ΔT, following which Q will be pushed down stream at the same rate q**.

The relationship is established by balance of material:

$${q}^{⋆} ( Q / {q}^{⋆ ⋆} + Δ T ) = Q$$

Rearranging:

$$Q ( 1 - {q}^{⋆} / {q}^{⋆ ⋆} ) = {q}^{⋆} Δ T$$

$$Q = {q}^{⋆} Δ T / ( 1 ‐ {q}^{⋆} / {q}^{⋆ ⋆} )$$

which says that given a continuous flow at a rate of q*, it is possible to find many combinations of Q, ΔT, q** such that the continuous flow will be interrupted by a ‘Quantum Section’ (QS) in which a quantity of fluid Q will be treated as batch for an arbitrary period of time ΔT. And there is no limit on how many quantum sections are fitted sequentially into a continuous flow, QS₁, QS₂, . . . where each ‘quantum section’ can be built with its own composition of Q, ΔT, and q**. Quantum sections can also be configured in parallel. Given a set of Q, ΔT, q**, it is possible to put t QS in parallel where:

$${QS}_{i} is defined by \{ {Q}_{i} , Δ T , {q}_{i}^{**} \}$$

where:

$$Q = \sum {Q}_{i} ; {q}^{⋆ ⋆} = \sum {q}^{⋆ ⋆} i for i = 1 , 2 , … t$$

In practice, the interface between a continuous flow and a quantum section, or between two quantum sections can be built with a capacitor—a fluid container that is accumulated slowly by input and is emptied fast to the output, again and again. We describe ahead various embodiments of the MMP platform. (Fluid Operating Platform, FOP)

### 2.0 MULTI-MODE PISTON (MMP)

A simple piston P is a plate of arbitrary contour moving smugly back and forth inside a ‘sleeve’ containing a fluid. The sleeve may be a closed capsule or an open pipeline. The plate may have holes drilled in it which may be in an open or closed position. The piston operates on. captured quantum of fluid. To capture a quantum of fluid one envisions a container with a number of openings for inflow and outflow, to be regarded as a capsule. The capsule will contain a dynamic element that can impact momentum to the captured quantum of fluid.

To achieve a most comprehensive movement of the fluid one may envision a piston featured with holes. As the piston moves inside the capsule, it forces the fluid to move through the opened holes on its surface. In a simple embodiment one envisions the capsule to be a cylinder of diameter d and length 1, and the a piston of diameter d and thickness h that moves along the cylinder from its first circular edge to its second circular edge. The quantum of fluid, Q is:

$$Q = ( 1 / 4 ) ( l - h ) * π * {d}^{2}$$

Ignoring the small amount of fluid captured in the holes of the piston. The holes of the pistons are routes for fluid flow, and thus one envisions a variety of shapes, sizes, bearings, and geometric configurations for these r routes, holes. The greater the variety of holes the greater the degree of freedom assumed by the AI controller of the device.

It is further easy and natural to allow a piston to rotate over its axis. Thereby a particular hole will be rotatable through the volume of the capsule. So far one describes a piston that runs across the capsule while at any moment any number of its holes is either open or close, and the entire piston rotates one way or the other at an arbitrary speed. The speed and the acceleration of the moving piston are additional degree of freedom. Same for angular momentum of the piston and its rotational acceleration. Furthermore, the holes in the piston may open and close at a desired rate, and may even be considered as partially open and partially closed. More degrees of freedom may be acquired by fitting the capsule with more pistons than one.

The capsule may be surrounded by a “pipe web”: an array of pipes that connect into the capsule at various locations. Each pipe may be an inlet or an outlet. The pipe web of several capsules can be pipe-connected. This builds up to a Fluid Operating Platform, FOP.

The overall operation of the web of MMP units may represent a full chemical manufacturing line. There are various power options to supply the kinetics for MMP unit.

Describing here a FOP, a constellation of capsules connected to a web of pipes, within which there are one or more pistons which are capable of moving axially and rotate around their axis. The pistons are fitted with fluid passage holes of various size, shape, bearing, configuration. This large set of degrees of freedom will be managed by a process controller using the available control points to deliver an optimized process. AI is the promising candidate for handling this task. While nominally the piston is a disc of fixed thickness δ, a piston P may be of any shape. The only requirement is that the piston move snugly inside its motion guiding sleeves, both directions back and forth. The piston separates between the fluid on one side of platform P and the fluid on the opposite side of P.

By convention we refer to a piston moving horizontally, with motion from left to right regarded as forward, and motion right to left regarded as backwards.

The piston P is either circular (e.g. a disc) or it has a built-in circular component. The circular component can rotate in both directions: positive clockwise ω+, and negative counter clock wise ω−.

The circular component of P is drilled with h holes, of various shapes, size and directions. Each hole may be fully open, fully closed or partially open. An open hole allows fluid to pass through from one side of the piston to the other and vice versa. The walls of the h holes that face the piston fluid (the fluid separated by the piston to two sections, ahead and arear of the piston) are designated as the ‘contact walls’.

A state of a piston P at time t is defined by the following parameters:

$$\{ Piston State at time t : \} P ( t ) = \{ x ( t ) , ω ( t ) , {h}_{1} ( t ) , {h}_{2} ( t ) , … {h}_{h} ( t ) \}$$

where x is the lateral position of P in the sleeve, (the capsule), ω is the rotational position of P, and hᵢ is the state of hole i (i=1, 2, . . . h) open, closed, or partially open.

P(t) from time point t₁ to time point t₂ where Δt=t₂−t₁ represents the dynamics of the piston over Δt.

When a piston is in a fixed lateral position, fixed rotational position, and a fixed state of the holes where at least one hole is at least partially open, over a period of time Δt, we say that the piston is in neutral state over Δt.

Similar evaluation applies to pistons with built in rotating discs.

To capture a quantum of fluid one envisions a container with a number of openings for inflow and outflow, to be regarded as a capsule. The capsule will have to contain a dynamic element that can impact momentum to the captured quantum of fluid.

It is further easy and natural to allow the piston to rotate over its axis. Thereby a particular hole will be rotatable through the volume of the capsule.

Above is a description of a piston that runs across the capsule while at any moment any number of its holes is either open or close, and the entire piston rotates one way or the other.

The holes in the piston may open and close at a desired rate, and may even be considered as partially open and partially closed.

More degrees of freedom may be acquired by fitting the capsule with more pistons than one.

### 2.1 Holes Configuration

A simple hole has a round opening and is parallel to the moving axis of the piston. The length of the simple hole is the thickness of the piston and the diameter of the hole is limited by the size of the piston and the presence of other holes through the same piston. The location of the hole is characterized by the distance of its center from the center of the piston. Angular position is flexible because the piston rotates around its axis. Holes are drilled in particular mutual configuration over the area of the piston.

The openings of the holes does not have to be round, and it can be any closed loop shape. Also, the opening on one side of the piston does not have to be of the same shape as on the opposite side. A simple hole is drilled perpendicular to the surface of the piston, but this is not necessary, a hole can be drilled at any angel to the axis, and the angel may change through the position of the hole. In particular holes can be drilled so as to maximize the contact area between the flowing fluid and the walls of the hole.

While the length of each hole in a piston is limited by the thickness of the piston, the operator may attach two or more pistons such that the outlet of a hole in one piston will be the inlet of a hole in the second piston, thereby the effective thickness of joint holes is the combined thickness of the attached pistons.

Furthermore, the holes can be drilled such that the size of the opening and the position of the opening changes in the distance between one face of the piston to the other.

All these degrees of configuration freedom can be used to optimize the desired process. Different holes on the same piston can be constructed with different configurations.

### 2.2 Power Sources, and Add-Ons

The MMP will need power to move laterally inside the capsule, to rotate, and, to change the status of the holes. Power sources may vary. A nominal piston is powered up through an external force on its axis, through an engine, a motor, or an elaborate set of levers. More intricate solutions is an MMP size electromagnetic power source with a built-in rechargeable battery, and Bluetooth control.

A MMP with n pistons may divide the volume of the capsule to (n+1) sections which can grow and shrink in size. Any MMP unit built with n pistons may be operated as an MMP with m <n pistons, by putting (n-m) pistons abreast of each other so they function as a single piston. Two pistons that are put one next to the other may rotate one relative the other and thereby change which holes are blocked and which are open through these two attached pistons.

The capsule may be fitted with sleeve heat exchangers enveloping the capsules. It also may be fitted with sampler probes, small inserts that are used to analyze some properties of the quantum fluid inside the capsule.

Capsules may have their internal parts on a mechanical switch around mode, where one piston can readily replace another.

### 2.3 Multi Mode Piston Sequence (MMPS)

A multi-mode piston sequence (MMPS) is a set of sequential MMP that operates in a coordinated way to achieve a fluid related objective. Each MMP is moving back and forth along its lateral motion axis, and each MMP is surrounded by a ‘sleeve’ that snugly fit the contour of the MMP (the piston). The sleeve may be a closed capsule, or an open pipeline. One sleeve may be shared among two or more pistons, or each piston may operate in its own sleeve. The sleeves of the platform contain the operated-on fluid. The sleeves may feed one into the other directly or they may be connected through a capacitor, a fluid container sufficiently large to accommodate flow rate differences in the process.

The MMPS is then further constructed into a Fluid Operating Platform, FOP.

Am MMP Sequence (MMPS) may feature n pistons P₁, P₂, . . . Pₙ. A full definition of the Sequence over a period of time Δt is given by dynamic description of the n pistons.

$$MMPS ( t ) = \{ {P}_{1} ( t ) , {P}_{2} ( t ) , … {P}_{n} ( t ) \}$$

Defining a zero state of the sequence, MMPS-0(Δt) over a period of time Δt as one where all the pistons Pi are in a fixed location, cᵢ, fixed rotational spots, wᵢ and at least one hole is at least partially open.

$${P}_{i} , x = {c}^{i} , ω = {w}_{i} ( ‘ 0 ’ ) ( t ) for t over Δ t , for i = 1 , 2 , … n$$

### 2.3.1 MMPS-1.0.

The simplest Multi Mode Piston Platform (MMPS-1.0) is a single multi-mode piston moving back and forth in a fluid conduit.

One imagines a pipeline, p, of inner diameter, d, filled with a fluid f. Inside pipeline p a multi-mode-piston, P, is placed at lateral spot a. P can be moved inside the pipe p from point a to point b. P can move back from point b to point a. This motion back and forth can be repeated at will. P can be in ‘open’ state, P(0) where certain holes on its surface are in open state, or P can be in ‘closed’ state, P(1), where all holes are closed.

We define a “pumping” sequence as follows:

Point a is identified as x=0, and point b as x=1. Pₓ₌₀ denotes P at point a Pₓ₌₁ denotes P at point b
1. place P at point a, in Closed state: Pₓ₌₀(1)
2. move P from point a to point b: Pₓ₌₀(1)→Pₓ₌₁(1)
3. change state of P from closed to open: Pₓ₌₁(1)→Pₓ₌₁(0)
4. move P from point b to point a: Pₓ₌₁(0)→Pₓ₌₀(0)
5. change state of P from open to closed: Pₓ₌₀(0)→Pₓ₌₀(1)
Step 5 is equal to step 1 so this sequence can repeat itself indefinitely.

This sequence will pump fluid in the pipeline in the direction from point a point b.

### 2.3.2 MMPS-2.0

MMPS-2.0 is a platform of two MMP sharing a sleeve
j6221

The two pistons can pump together synchronized. They can also capture a quantum of fluid between them, then perform a pressure impact dynamics where they either increase the pressure of the captured quantum of fluid, or develop vacuum thereto.

Pressure is applied by the two pistons exercising a pumping procedure in opposite direction. each pushing fluid towards the opposite piston.

Vacuum is applied by the two pistons exercising a pumping procedure in opposite direction. each pushing fluid away from the opposite piston.

If the sleeve section between the pistons has a pipe opening then by increasing the pressure the fluid between the pistons will by pushed through this opening, and by developing vacuum therein outside fluid can be sucked into the sleeve.

Any one of these pistons may be in neutral position over an interval of time Δt so the other piston operates in MMPS-1.0 mode.

### 2.3.3 MMPS-3.0

MMPS-3.0 is a platform comprising 3 pistons (MMPs) sharing a sleeve. Any of these pistons can be in a neutral position thereby allowing the other two to operate as MMPS-2.0 and MMPS-1.0.

We mark the three pistons 1, 2, 3 by order. Piston 2 is the middle one and 1 and 3 are the edge pistons.

MMPS-3.0 is called the ‘mixing mode’ because the three pistons can accomplish a mixing act over the piston fluid.

Mixing happens when the middle piston moves back and forth between the two edge pistons while rotating and having some or all of its holes open.

Mixing can happen in an ‘enclosure mode’ or in a ‘pipeline mode’. In the enclosure mode the two edge pistons are kept fixed, the fluid captured between them is regarded as the quantum fluid, Q. Q is mixed by allowing the middle piston to move back and forth between the edge pistons. When mixing is done, the middle piston changes to closed status and pushes the quantum out through piston 3 while sucking in a new quantum through piston 1.

In a pipeline mode, the two edge pistons slowly move away from each other as the middle piston is moving in a faster pace, traverses from one edge piston to the other, each time it has a larger distance to cover to go to the other piston.

In a pipeline mode the three pistons are first place-adjacent. next to each other. And then the edge pistons move away from each other (slowly, in a partially open state) and the middle piston is running (fast) back and forth between them. The edge pistons are less open than the middle piston so that when the middle piston moves towards that edge piston there is less resistance for the fluid to pass through the fast moving middle piston than through the slow moving edge piston.

### 2.3.4 MMPS-4.0

A sequence of 4 MMPs can be used for a different protocol of mixing, as follows:

Let pistons 1 and 4 be the edge pistons on a fixed location. Pistons 2 and 3 positioned in the middle, x=0.5, spot. Both 2, and 3 pistons set to open state, while pistons 1 and 4 are set to closed state. Pistons 2, 3 move each to its edge piston both in open state. Pistons 2, 3 rotate while so moving. When pistons 2, 3 arrive to a state of being abreast of their corresponding edge piston, the entire quantum of fluid captured between the edge pistons has undergone a round of mixing.

Next, the edge pistons remain closed, and pistons 2, 3 move back to the middle (starting position), while rotating and in an open or partially open state. When pistons 2, 3 meet, the quantum of fluid between the edge pistons, Q, has undergone a second round of mixing.

Such rounds of mixing can repeat at will.

MMPS-4.0 can be used for separation, as follows:
1. The fluid space between the edge pistons 1, and 4 is comprised of a solution of ingredients A and B. These pistons are positioned at points a and b in the pipeline respectively, they both are closed. P₁₍ₓ₌₀₎(1), P_{4(x=1.0)}(1)). Pistons 2 and 3 have holes that apply a preference for component A of the solution over component B. They are both positioned at x=0 abreast with piston 1, in open state.
2. From the above starting position, pistons 2 and 3 are being moved towards position x=0.5. Because of the A-B discrimination property of holes in pistons 2 and 3, the half of the quantum left of the pistons 2 and 3 (from x=0 to x=0.5) is now richer with component A, while the right side (from x=0.5 to x=1.0) is richer in component B. The next stage is to separate the two halves of the quantum, the right half from the left half This is accomplished as follows:
3. piston 2 is moved back from x=0.5 to x=0.0 while in fully open state, and then shifts to closed state:

$${P}_{2 , x = 0.5} ( 0 ) \to {P}_{2 , x = 0} ( 0 ) . {P}_{2 , x = 0} ( 0 ) \to {P}_{2 , x = 0} ( 1 ) .$$

Piston 3 is left in place and shifts to closed state: P_{3,x=0.5}(0)→P_{3,x=0.5}(1).
4. Pistons 1 and 4 are shifted to open state, P_{1,x=0}(1)→P_{1,x=0}(0), P_{4,x=1}(1)→P_{4,x=1}(0).
5. Pistons 2 and piston 3 are moved in tandem half of x length to the right, as both pistons are in closed state

$${P}_{2 , x = 0} ( 1 ) \to {P}_{2 , x = 0.5} ( 1 ) ; {P}_{3 , x = 0.5} ( 1 ) \to {P}_{3 , x = 1.} ( 1 )$$

This action pushes the right half of the fluid between the edge pistons into an external receptor. When the right half is fully pushed out, the left side of the quantum has been pushed by piston 2 to occupy the space previously held by the right side of Q. And as piston 2 moves to the right (in closed state) while piston 1 is open, a new half of a quantum of fluid is being pulled in to occupy the space previously occupied by the left part of the Q, which was B-rich.
6. The receptor hole of the fluid from the MMPS is switched to another receptor, and piston 2 pushes the A richer half between it and piston 3 (which is now abreast with piston 4), out to a new receptacle. As this pushing out happens, the space between the edge pistons is filled with new mixed fluid from the inlet source. When done, piston 2 is at x=1.0 position, abreast with piston 3 (next to piston 4). At this point the B-rich half of Q is already pushed out separately from the A-rich half and the space between pistons 1 and 4 is filled with new fluid.

$${P}_{1 , x = 0} ( 0 ) ; {P}_{2 , x = 0.5} ( 1 ) \to {P}_{2 , x = 1} ( 1 ) ; {P}_{3 , x = 1} ( 1 ) \to {P}_{3 , x = 1} ( 0 ) ; {P}_{4 , x = 1} ( 0 )$$

7. Pistons 2 and 3 are moved from x=1 position to x=0 position abreast with piston 1. The movement is done with both pistons in open state.

$${P}_{1 , x = 0} ( 0 ) \to {P}_{1 , x = 0} ( 1 ) ;$$

$${P}_{2 , x = 1} ( 1 ) \to {P}_{1 , x = 1} ( 0 ) ; {P}_{2 , x = 1} ( 0 ) \to {P}_{2 , x = 0} ( 0 ) ;$$

$${P}_{3 , x = 1} ( 0 ) \to {P}_{3 , x = 0} ( 0 ) ;$$

$${P}_{4 , x = 1} ( 0 ) ) \to {P}_{4 , x = 1} ( 1 ) ;$$

This brings the system to its state after step 1 above. Steps 2 to 7 can repeat indefinitely, each round another Q quantum of fluid is being separated to a half richer in A and a half richer in B.

This analysis is equally applied to a different partition of the quantum of fluid, other than half-half.

### 2.3.5 MMPS-5.0

MMPS-5.0 may be used as a double mixer. Piston 1, 3, and 5 are stationary, and pistons 2 and 4 move back and forth. P₂ moves back and forth between x=0 and x=0.5 where piston 3 is fixed, and piston 4 will move back and forth between x=0.5 to x=1.0 where piston 5 is fixed.

When the two sections mixing is done, pistons 2, 3, 4 will all move left to position x=0, put in a closed state and push the mixed quantum through fixed place open-state piston 5 to the next stage while new pre-mixed fluid comes through open-state piston 1.

### 2.3.6 MMPP-n

In general an MMP platform with many pistons may be viewed an a succession of process steps in a series of action elements in a full line of fluid processing.

### 2.4 MMP Capsules

An MMP capsule is a fluid container featuring one or more MMPs. It has one or more inlets, and one or more outlets. It may have heat exchange options on parts or all of the capsule.

Capsules may be positioned horizontally, diagonally or vertically.

Simple capsules are shaped as a cylinder. Advanced capsules are shaped as “bricks”, “beams” or of any desired cross-section with an elongated axis where the pistons are placed.

### 2.4.1 Cylinder Shaped Capsules

In a cylinder capsule the piston fits snugly to the contour of capsule. As the piston moves inside the capsule, it forces the fluid to (i) either move ahead of it—when the piston is in closed state, or (ii) move through the opened holes on its surface. One envisions the capsule to be a cylinder of diameter d and length l, and the a piston of diameter d and thickness h that moves along the cylinder from its first circular edge to its second circular edge. The quantum of fluid, Q is: Q=(¼)(1−h)*π* d² Ignoring the small amount of fluid captured in the holes of the piston.

The holes of the pistons are routes for fluid flow, and thus one envisions a variety of shapes, sizes, bearings, and geometric configurations for these routes, holes. The greater the variety of holes the greater the degree of freedom assumed by the AI controller of the device.

### 2.4.2 Non-Cylinder Bar Capsules

Non-cylinder capsules have a non-circular cross section. The pistons in them share the same cross section. Such pistons cannot rotate unless they have built-in rotating discs.

### 2.4.2.1 Non Rotational Pistons

Non-rotational pistons may have any desired cross section, may have any number of holes in them, but they don't rotate. They do maintain the full variety of keeping any combination of holes open or closed as desired. The operation of a non-rotational piston may be degraded compared to the rotational one of similar parameters, but they are simpler to build and simpler to operate.

### 2.4.2.2. Built-In Rotational Disc Pistons

Built-in rotational discs pistons, have circular cut outs that are replaced with rotational discs in which various holes are drilled as in a circular piston. Each disc can circulate independently of the other in terms of angular speed, direction, and phase coordination. Thereby establishing a great degree of freedom in terms of manipulating the quantum of fluid in the capsule.

In particular rectangular-bar capsules are readily packed into a tight MMP capsule.

### 2.5 MMP Platforms, MMPP

An MMP platform is a network of MMP capsules, where each capsule contains one or more sequential MMPs. The capsules may be connected directly, or via fluid capacitor. The latter allows for more flexibility to handle rate differences between parts of the process.

The capsule may be surrounded by a “pipe web”: an array of pipes that connect into the capsule at various locations. Each pipe may be an inlet or outlet. The pipe web of several capsules can be pipe-connected.

The overall operation of the web of MMPS may represent a full chemical processing from raw materials to products, by products and refuse.

There are various power options to supply the kinetics for MMPP. Capsules may be well packed and directly connected, especially rectangular-bar capsules.

Summary: Describing a picture of capsules connected to a web of pipes, within these capsules there are one or more pistons which are capable of moving axially and rotate around their axis. The pistons are fitted with fluid passage holes of various size, shape, bearing, configuration. Processing versatility is achieved by allowing the pistons to move laterally while rotating and while having each hole be at any time either close or open.

This large set of degrees of freedom will be managed by a process controller using the many control points to deliver an optimized process. AI is the promising candidate for handling this task.

A capsule may feature any number of sequential pistons (MMPs). They can be maneuvered in a variety of ways to achieve a variety of process objectives. These capsules can be connected directly or through a capacitors, and together form an MMP platform.

MMPs may be lined up in any combination, connected through a maze of pipelines that route fluid from one MMP to the next. Backward flow is permitted. MMPs may be connected via capacitors to regulate flow. MMPs of various sizes (capacities and geometries) may be fitted together because flow rates may be adjusted by the dynamics of the MMPs.

A MMP lineup (MMP-LU or MMP Platform, MMPP) may feature horizontal, vertical or slanting MMPs.

The MMP-LU will include kinetic systems to impart the motion (lateral and rotational) to the pistons as well as to open and close each passage way in each piston.

The MMP-LU will be controlled through a control center that will be fed by relevant process reading and will include controls on all the degrees of freedom of the lineup. The control unit will include the computing device and the AI capability in order to optimize the control of the LU.

### 2.5.1 Packed Bar MMP Capsules Platform

Rectangular bar capsules may be packed into a compact assembly with any number of fluid connection ports (FCP) allowing for fluid to flow from one capsule to another. This allows for the full contents of the platform to be at any point divided to q quantums. Each of the quantum may be of any size up to P, the volume of the entire platform, subject to the conditions that the sum of the volumes will be limited by the volume of the platform, P.

$$\sum {v}_{i} = P . for i = 1 , 2 , … q$$

where vᵢ is the volume of quantum i. At some time point t quantum of fluid qᵢ of volume vᵢ may be moved to any location on the platform.

Any quantum qᵢ, locating not at the left edge of a capsule may be moved to the left as follows:

Let piston pᵢ be on the left of qᵢ, and piston pᵣ be on the right side of qᵢ. Let piston pf be the piston forward of qᵢ towards the left edge and left of pᵢ. In order to move qᵢ to be captured between pᵢ and p_{f} do:

$$1. {p}_{f} ( 0 ) . ( open {p}_{f} ) 2. {p}_{l} ( 0 ) ( open {p}_{l} ) 3. {{p}_{r} ( 1 )}_{x = x r} \to {{p}_{r} ( 1 )}_{x = x l}$$

where xₗ is where pₗ is located before the procedure, and xᵣ is where pᵣ is located before the procedure. This procedure moves qᵢ to be captured further to the left of the capsule between pₗ and p_{f}.

Applied again this procedure will move any quantum of fluid further to the left of its capsule. By symmetry a corresponding procedure will move any quantum to the right of its capsule.

Properly applying, every part of fluid in the platform can be defined as a quantum of fluid and be moved throughout any MMP capsule bar. That means such quantum can be moved to fit above an FCP and be transported to the adjacent capsule.

When a quantum of fluid is positioned over an FCP it can be moved to the next capsule as follows:

Let q be the quantum planned to move from a sending capsule to a receiving capsule. The are two encompassing pistons enclosing on q, and are kept in closed state.

The moving of q is done as follows:
1. The FCP is opened,
2. the two pistons enclosing on q are set in closed state and are being moved towards each other, pushing q through the FCP to the adjacent capsule.

$$1. {{p}_{l} ( 1 )}_{x = l} \to {{p}_{l} ( 1 )}_{x = c} 2. {{p}_{r} ( 1 )}_{x = r} \to {{p}^{{}_{′}} ( 1 )}_{x = c}$$

where x=1 and x=r are the positions of pₗ and Pᵣ before the procedure starts.x=c is the position of the FCP.
2. The two pistons in the receiving capsule, p′ₗ, p′ᵣ, positioned first abreast of the FCP (x=c) perform the following procedure:

$$1. {{p}_{l}^{′} ( 1 )}_{x = c} \to {{p}_{l}^{′} ( 1 )}_{x = {c}^{′}} 2. {{p}_{r}^{′} ( 1 )}_{x = c} \to {{p}^{′} ( 1 )}_{x = {c}^{″}}$$

where c′ is a position left of c, and c″ is a position right of c, and where c′ and c″ comply with the following:

$$A * ( r - l ) = {A}^{′} * ( {c}^{″} - {c}^{′} )$$

where A is the cross sectional area of the capsule passing the quantum of fluid, and A′ is the cross sectional area of the capsule receiving the quantum of fluid. This relationship simply equates the volume of the transferred quantum of fluid between the passing capsule and the receiving capsule.

This procedure can be applied to any quantum in the platform: to move this quantum to any part of the platform.

Considering n capsules, with m multimode pistons each (nm pistons altogether), piston pᵢⱼ designates piston j in capsule i. The location span of each capsule ranges from x=0 (left edge) to x=1 (right edge). Pᵢⱼ at time t is positioned at location xᵢⱼ(t), at which time it open/closed state can be either s=0 (open), or s=1 (closed). In a more elaborate analysis different stages and combinations of open/close holes can be tracked). By this analysis we define two matrices: X(t), comprising xᵢⱼ for i=1, 2, . . . n and j=1, 2, . . . m, and state matrix S(t) comprising nm elements sᵢⱼ. Analyzing the dynamics of platforms over a period of time ΔT one can divide ΔT into z intervals of equal durations, and thereby represent X(t) and S(t) as corresponding tensors X*, and S* with nmz elements each xᵢⱼₖ, and sᵢⱼₖ respectively where i=1, 2, . . . n. j=1, 2, . . . m and k=1, 2, . . . z.

These tensors must obey certain rules:
1. balance of materials: for k=1, 2, . . . z:

$${Q}_{platform} = \sum \sum {A}_{i} * ( {x}_{ijt} - {x}_{i , j - 1 , t} )$$

where Aᵢ is the cross sectional area of capsule i.

$$2. For i = 1 , 2 , … n . for j = 1 , 2 , … m \\ {x}_{ij} \leq {x}_{i , j + 1} ,$$

reflecting the fixed order of the pistons in the capsule.

Given any filled platform, AI engines can map any MMP dynamics into these tensors and then apply inferential tools to steadily optimize towards an optimal strategy to achieve a declared objective.

Formally the above analysis refers to the edges of the capsules as piston p₀ and pₙ₊₁ respectively.

The above analysis can be extended to a three dimensional packed platforms where u platforms with w capsules each, comprising uw capsules and each capsule cᵢⱼ for i=1, 2, . . . u and j=1, 2, . . . w has m pistons pᵢⱼₖ for k=1, 2, . . . m. These uwm pistons are at any point of time t at location xᵢⱼₖ, and at open/close status sᵢⱼₖ. An effective data structure for AI analysis.

These analysis can be further refined by fitting any number of inlets and outlets into the platform.

### 3.0 UNIT OPERATIONS

The assembly of a series of MMPs moving inside a capsule may be used to manipulate fluids in a complete and minute manner. There are plenty of degrees of freedom.

We discuss some basic operations: (i) pumping, (ii) mixing, (iii) reacting, (iv) separations, (v) storage

The MMP may be put in idle state where it stays in a passive position and does nothing.

### 3.1 Pumping

The most basic unit operation for the MMP is pumping. A piston P may be positioned at spot x (Pₓ) where x defines a lateral spot within the capsule cylinder such that x=0 is left edge of the capsule while placed horizontally, and x=1 is the right edge of the capsule. The holes of Pₓ may be open Pₓ(0), or closed Pₓ(1). In practice each hole may be partially open in θ possible states, for h holes in a piston there are. θ^{h} different states for the piston to be in. But to present the issues herein it is sufficient to consider only two states: full open (0) and fully closed (1).

The left edge of the capsule Eₗ may be open Eₗ(0) or closed Eₗ(1). And similarly for the right edge Er may be open Eᵣ(0) or closed Eᵣ(1).

Both edges are connected to fluid flow elements, configuration:

$$[ Inlet ] - MMP - [ Outlet ]$$

We first define an idle state:

$$[ idle state ] = {E}_{l} ( 0 ) , {P}_{x} ( 0 ) , {E}_{r} ( 0 )$$

for any value of x: 0≤x≤1. In an idle state all passage ways (holes) are open and it does not matter what is the position of the piston.

In order to use the MMP to effect flow from the inlet to the outlet, do:

Set the MMP at the starting state:

$$1. {E}_{l} ( 0 ) , Px = {}_{0} ( 1 ) , {E}_{r} ( 0 )$$

Move P from x=0 to x=1 with holes closed: P₀→P₁(1), Q-suction.

This amounts to suction of a quantum Q of fluid from the inlet into the capsule.

The MMP is then set to the fill-up state:

$$2. {E}_{l} ( 1 ) , {P}_{1} ( 0 ) , {E}_{r} ( 1 )$$

Move P from x=1 to x=0 with holes open: P_{1→0}(0).

With this motion the quantum of fluid Q captured in the capsule is passing through the open holes of the MMP from the left side of the piston to the right side of the piston. The MMP system then being set at the restart state:

$$3. {E}_{l} ( 0 ) , {P}_{0} ( 1 ) , {E}_{r} ( 0 )$$

Once again one moves P from x=0 to x=1 with holes closed: P_{0→1}(1). This sucks in another Q quantum of fluid from the inlet to the MMP, while pushing the former Q from the MMP to the outlet, effecting the net pumping action.

The MMP capsule may be constructed in very small dimensions or in very large dimensions.

We first discuss (1) MMP pumps in a series, (ii) in-line MMP pumping.

### 3.1.1 MMP Pumps in a Series

One can string n MMP pumping units in a series: U₁, U₂, . . . Uₙ, MMP i feeds MMP (i+1) for i=1, 2, . . . (n−1).

The units may be synchronized or non-synchronized. In a synchronized mode the flow rate of all units must be the same. In a non-synchronized mode there are two options: capacitor mode, and line mode. In a line mode only one of the non-synchronized MMP units will be engaged in pumping, the other will remain idle. The selected one can change at will. In a capacitor mode between every two MMP units there will be a fluid container with room for the fluid content to rise and fall, to account for the differences between the flow rates of the MMP units. The larger the capacitor the larger the accommodated differences between the flow rates.

### 3.1.2 Inline MMP Pumping

The MMP capsule could be a continuation of a pipeline, and be continued by a pipeline, so that the MMP unit is completely inside the pipeline where the fluid flows. Several MMP in line can be fitted in such a pipeline. Thereby increasing the pumping capacity in the line.

### 3.1.3 Parallel Pumping

A feed line can break out to u MMP capsule units in parallel. The output of the u capsule units will be united to a single flow. In that case the overall pumping capacity is the sum pumping of the individual capsules. Capsule pump i=1, 2, . . . u, with cross section Aᵢ, with a lateral moving span xi, with a frequency of rounds fᵢ per minute, will pump Aᵢ*xᵢ*fᵢ liters/minutes, and the total pumping capacity will be:

$$U = \sum {A}_{i} * {x}_{i} * {f}_{i} for i = 1 to i = u$$

while generally the cross sections cannot be dynamically changed, the literal moving span and the frequency of rounds can be adjusted dynamically among the k pumps, allowing for better maintenance and operational flexibility.

### 3.2 Mixing

Mixing can be done in conjunction with pumping or in a stand-alone mode.

Stand-alone mixing is similar to inline mixing with the difference that the inlet and the outlet are one and the same.

### 3.2.1. Mixing-Pumping

Pumping-Mixing operates like pumping with the following difference: The quantum of fluid, Q, is comprised of either one pre-mixed stock or, the quantum of fluid, Q, is comprised from inflow of two or more inlet lines, so that Q is comprised of two or more ingredients.

After the initial suction-pushing motion, the MMP undertakes any desired number of “mixing steps”, followed which the MMP unit undertakes the restart motion, followed by a Q-pushout motion. The mixing-pumping operation is a pumping operation interrupted with mixing steps. The more mixing steps, the lower the pumping capacity.

$$[ pumping - mixing ] = [ Q - suction ] [ Q - mixing ] … [ Q - mixing ] [ Q - discharge ]$$

A pumping-mixing step is defined as follows:
1. Starting state: Eₗ(1), Pₓ₌₁(0), Eᵣ(1)

Namely the edges are closed (locking a quantum of fluid Q in the capsule), and the piston is open, located at the right edge.

Mixing begins with a “left squeeze” in which the piston starting at x=1 position is moving towards x=0 position while at least one of its holes is open, and the piston may, or may not rotate while it moves from the right edge to the left edge. This movement squeezes the entire quantum of fluid through the open holes as the holes traverses from position x=1 to position x=0.

Mixing continues with a “right squeeze in which the piston starting at x=0 position is moving towards x=1 position while at least one of its holes is open, and the piston may, or may not rotate while it moves from the right edge to the left edge. This movement squeezes the entire quantum of fluid through the open holes as the holes traverses from position x=0 to position x=1.

### 3.3 Reacting

A reactor is constructed by applying a mixing procedure while as needed applying reaction support. This support is effected through the surface area that contains the quantum of fluid. This surface area may support the reaction via its chemistry, its material, or by allowing external influence onto the quantum. The first kind will apply to catalytic impact, or to direct chemical activity between the surface material and the quantum of fluid. The second kind applies to temperature adjustment and various radiations coming from the outside in.

We distinguish between the capsule surface and the surface of the passage ways drilled into the piston. The latter enjoy a more intimate more dynamically controlled contact with the captured fluid.

The natural way to adjust the temperature inside the reactor is to place across the contact surface on the outside, a temperature adjusting fluid (either hot or cold) and allow the stream of this temperature-adjusting fluid to have good surface sharing with the temperature adjusted fluid, Q.

It is easy to place the temperature-adjusting fluid around the heat conductive capsule but it is more effective to build the piston hollow so that it is possible to pump through its inside volume a hot or cold fluid as the case may be, and let this temperature-adjusting fluid exchange heat with the temperature adjusted fluid that is squeezed through the fluid passageways. Similar for radiation impact through the surface.

The reactor MMP unit may also be equipped with online probes, to take measurements of the state of the quantum of fluid to be used by the MMP controller to carry out an effective reactor operation. Some such probes, sensors, apply radiation from the outside, and measure the radiation that emerges from Q to infer upon the state of Q. Other probes include a mechanism to sample Q to an external area where the properties of the sample are directly examined.

### 3.4 Separations

Separation is achieved through an effective discriminator between the unseparated ingredients. Such discriminators are: gravity, electro magnetic impact, or contact of the quantum fluid with the surface area of the holes in the piston.

A standard separation protocol may be carried out as follows:

Let a quantum of fluid Q, be comprised of two ingredients A and B (it is easy to extend the below to more ingredients). Effecting some separation process, the quantum is not unform but the right part (we will use half but it can be extended to other ratios) is richer with A while the left part is richer with B. Or, if the MMP is vertical, the lower part is richer with A and the higher part is richer with B.

The aim is to separate the two distinguished parts, The MMP Capsule unit will be equipped with two MMPs, a right one and a left one, Pₗ and Pᵣ (or lower one and a higher one for the vertical situation).

The capsule will have two outlets, each fitted into an edge of the capsule, one right, one left, (Eₗ, Eᵣ) and one inlet fitted into the middle of MMP capsule (x=0.5), I.

So all together the separation capsule unit has two stationary pistons (edge pistons), (Eₗ, Eᵣ) and two inside pistons that move from right to left and back: Pₗ and Pᵣ

Starting with an empty MMP capsule do:
1. position the two pistons, Pₗ and Pᵣ at x=0.5, passageways closed, while opening I, Eₗ, Eᵣ:

$${P}_{l} ( 1 ) [ x = 0.5 ] , {P}_{r} ( 1 ) [ x = 0.5 ] , I ( 0 ) , {E}_{l} ( 0 ) , {E}_{r} ( 0 ) \qquad ( i )$$

Move the right piston from x=0.5 to x=1, and move the left piston from x=0.5 to x=0. Thereby any remnant from previous operation of the MMP is being disposed of, and a quantum of fluid is being sucked into the MMP unit from the middle inlet I. When this step is concluded, the inlet I is closed and the system is in the following state:

$${P}_{l} ( 1 ) [ x = 0 ] , {P}_{r} ( 1 ) [ x = 1 ] , I ( 1 ) , {E}_{l} ( 1 ) , {E}_{r} ( 1 ) \qquad ( ii )$$

Now that the pre-separated quantum of fluid is in the MMP capsule, a separation process begins. This depends on the method of separation. When the separation inside the MMP is concluded the MMP is in state (iii):

$${P}_{l} ( 1 ) [ x = 0.5 ] , {P}_{r} ( 1 ) [ x = 0.5 ] , I ( 1 ) , {E}_{l} ( 1 ) , {E}_{r} ( 1 ) \qquad ( iii )$$

The next steps will separate the right side of the quantum, richer with A (Q_{A}) from the left side of the quantum, richer with B (Q_{B}) where: Q=Q_{A}+Q_{B}. (or separation between the lower and the higher side of the quantum for a vertical setting).

For separation we attach one vessel of volume Q (at least) to the left side (via a pipeline) of the MMP capsule, marking the vessel as: Vₗ, and a second vessel of volume Q (at least) to the right side of the MMP capsule, marking this vessel as Vᵣ. At the beginning the two vessels are empty.

The next step is to prepare the MMP capsule unit to push out each side of the quantums to their respective container, vessel. The MMP capsule unit is set into state (iv):

$${P}_{l} ( 1 ) [ x = 0.5 ] , {P}_{r} ( 1 ) [ x = 0.5 ] , I ( 0 ) , {E}_{l} ( 0 ) , {E}_{r} ( 0 ) \qquad ( iv )$$

The next step would be to move the two pistons to their respective sides thereby pushing the left side of the quantum Q to Vₗ, (Q_{B}), and the right side of Q to vessel Vᵣ (Q_{A}) (or high, low designation for a vertical MMP).

The two pistons push each, its side of the quantum to its respective end, while the volume that opens up between them sucks in another Q from the inlet I. When done Q_{A} is found in vessel Vᵣ, and Q_{B} richer in B is found in vessel Vₗ. while the MMP capsule is filled up with a new Q ready for another round of separation operation.

At the end of this displacement the MMP is in the following state:

$${P}_{l} ( 1 ) [ x = 0 ] , {P}_{r} ( 1 ) [ x = 1 ] , I ( 1 ) , {E}_{l} ( 1 ) , {E}_{r} ( 1 ) \qquad ( v )$$

This concludes a separation round wherein a quantum of fluid Q containing two ingredients A and B is split, half richer in A in one vessel, Vᵣ, and one richer in B in another vessel, Vₗ.

The division of Q to two halves may be replaced by any other division between the two distinguished parts of Q.

The situation now may be such that no more separation is needed and both parts of the separated Q may be taken to the next step of the overall process. But then again, it may be that more separation is needed. In this case what is needed is a separation iteration routine.

### 3.4.1 Separation-Iteration Routine

Following a separation round, another round may be carried out, at the end of which there will be a Q amount of fluid in V₁ and a Q amount of fluid in Vᵣ.

Such an MMP round (MMPR) may be set up iteratively. We describe a fluid that a-priori contains equal parts of two ingredients A and B. Considering a 2t-rounds setup as follows:

Set up (2t−1) containers, vessels, V₁, V₂, . . . V₂ₜ₋₁. where Vₐ for a=1, 2, . . . (2t−1) designates a vessel with a/2t level of ingredient A. (Recall, initially the Q has A and B in equal levels ½: ½).

When fluid from container Vₐ, for a=2, 3, . . . (2t−2) is processed through a MMPR it results in feeding fluid to container Vₐ₋₁, and into Vₐ₊₁.

A single MMP capsule unit will be used in any order to process the fluid in containers V₂, V₃, . . . V₂ₜ₋₁, so the fluid that comes into vessel Vₜ will iteratively migrate part into V₁ and part into V₂ₜ from where the separated fluids will be pumped out.

The procedure can be readily modified to apply more MMP units and less vessels.

Each separation round divides the quantum of fluid to two parts. So a second MMP unit will wait for two rounds of half-quantum input before it is processed, and a third MMP unit will wait for four input rounds before it is processed, and so on.

3.4.2 Gravity Based separation

Any ingredients that can be differentiated by gravity may be processed through a vertical MMP wherein the upper part of Q will be richer with the lighter ingredient, A, and the lower part of Q will be richer with the heavier ingredient, B.

Gravity separation is very efficient when the fluid is a gas rather than a liquid. It is of advantage to apply pressure-holding MMP over fluid that can be transformed from liquid to gas and vice versa.

Gravity can be simulated in centrifuges. Placing MMP capsules as the payload of a fast rotating accelerating apparatus.

### 3.4.3 Heavy-Light Immiscible Fluid Separation

This applies to liquids, not to gases. We envision a vertical MMP in state (ii) as described in the generic separation routine. All passageways are closed and the two pistons are each abreast of its edge.

Separation move happens when both pistons are in an ‘open’ state, close to their respective edges, the edges and the inlet are in a ‘closed’ state and the two pistons move towards each other. The higher piston, Pₕ stops at point x=a, and the lower piston, Pₗ stops at point x=b. b<a. Nominally one can set a=b=0.5. Ending at state:

$${P}_{h} ( 0 ) [ x = a ] , {P}_{l} ( 0 ) [ x = b ] , I ( 1 ) , {E}_{h} ( 1 ) , {E}_{l} ( 1 )$$

Each piston attracts fluid richer in one ingredient than in the pre-separated Q, and that richer fluid moves opposite to the movement of moving piston. The region above a is richer with the lighter fluid, and the region below b is richer with the heavier fluid. Thereby a distinct partition of Q per A-B separation is achieved. If this separation is carried out while the MMP capsule is in a fast-rotating centrifuge, then its efficiency is directly proportional to the centrifugal speed.

Next, the holes in the pistons are closed, and the holes in the edges are opened, same with respect to the inlet:

$${P}_{h} ( 1 ) [ x = a ] , {P}_{l} ( 1 ) [ x = b ] , I ( 0 ) , {E}_{h} ( 0 ) , {E}_{l} ( 0 )$$

Next the two pistons are moving each to its respective edge thereby pushing out fluid to two different containers the top part (richer with A) and the bottom part (richer with B). The middle part from x=b to x=a is mixed with the new inflow that flows in from I, creating the new quantum.

As the two parts are pushed out, the MMP capsule is refilled from the inlet I to enclose a new quantum of fluid ready to be separated.

### 3.4.4 Volatile Fluid Separation.

Given a mixture of A and B where A is more volatile than B such than when a quantity of such mixture is in a liquid phase and when its environment changes to transform it to a gas, then the part of the mixture that first is turning into gas, is richer in ingredient A, leaving the remaining liquid to be richer in ingredient B. Such volatility differences can be used to effect a separation through the following protocol:

The basic idea: fill up part of the vertical MMP unit with a mixture of A and B in liquid form. Create vacuum by pulling the higher piston, in closed state, above the surface of the liquid. This will fill the volume from the surface of the liquid to the upper piston with a mixed vapor of A and B. This gaseous mix will be richer with the more volatile ingredient A while the liquid phase will be richer with the less volatile ingredient B. The two phases now undergo separation. This is effected by setting both pistons to ‘open’ state and moving both to be placed at the surface level of the liquid. Once the pistons reach the surface level, both switch to closed state, then moving both pistons to their respective edge pushing each phase to its own container while feeding in a new quantum of fluid from the inlet.

The separation begins with the following state:

$${P}_{h} ( 1 ) [ x = 0.5 ] , {P}_{l} ( 1 ) [ x = 0.5 ] , I ( 1 ) , {E}_{l} ( 1 ) , {E}_{h} ( 1 )$$

The lower piston is moving down x=0.5→x=0, and Eₗ(1) →Eₗ(0), I(1)→I(0) while sucking in a liquid mixture of A and B from the inlet I. A measured amount of such mixture is pumped into the MMP capsule, until it fills the vertical MMP capsule to level x=m. If m>0.5 then the sucked in liquid is pulled in by raising the higher piston from Pₕ(x=0.5), to Pₕ(x=m).

When the intended amount of A and B liquid mixture has been fully entered into the MMP capsule, the two pistons move to position x=m, doing so at an open state. resulting in:

$${P}_{h} ( 0 ) [ x = m ] , {P}_{l} ( 0 ) [ x = m ] , I ( 1 ) , {E}_{l} ( 1 ) , {E}_{h} ( 1 )$$

Next the lower piston is moving to the down edge, at an open state, and the higher piston, in a closed state is moving to its upper side creating vacuum between the surface of the liquid (x=m) and the lower surface of the higher piston. When Pₕ is at x=1 the volume between x=m and x=1 is filled with a mixture of A and B in a gaseous state, where the ratio of A to B is higher than in the input stock and while the liquid phase from x=m to x=0 is higher with ingredient B.

This step ends up as:

$${P}_{h} ( 1 ) [ x = 1 ] , {P}_{l} ( 0 ) [ x = 0 ] , I ( 1 ) , {E}_{l} ( 1 ) , {E}_{h} ( 1 )$$

Next the two pistons change or stay at open state and they move respectively from x=1 to x=m and from x=0 to x=m, so the two pistons are placed at the borderline between the lower liquid phase and the upper gaseous phase. This step ends up as:

$${P}_{h} ( 0 ) [ x = m ] , {P}_{l} ( 0 ) [ x = m ] , I ( 1 ) , {E}_{l} ( 1 ) , {E}_{h} ( 1 )$$

Next the two pistons change to closed state, and each moves to its respective edge while the inlet is opened and a new quantum of fluid is pumped in. While the pistons move the two edges are open to allow the fluid to leave the MMP unit. Each edge connects to a different receiving device thereby achieving separation of the original Q.

At the end of this step the two pistons are abreast of their respective edges and the MMP capsule is filled with a new quantum ready for separation. This step ends up as:

$${P}_{h} ( 1 ) [ x = 1 ] , {P}_{l} ( 1 ) [ x = 0 ] , I ( 1 ) , {E}_{l} ( 1 ) , {E}_{h} ( 1 )$$

Note: when some liquid evaporates the level of liquid in the MMP is a bit lower than x=m, but not by much, so for better lucidity of description this change is being ignored.

In addition to vacuum it is possible to heat the MMP to increase the amount of transformation from liquid phase to gas phase.

### 3.4.5 Electro Magnetic Separation

Separations based on surface contact are implementable in MMP platform. But for others, like separation based on particle acceleration like in mass spectroscopy, MMP is irrelevant.

### 3.4.5.1 Electrophoresis

Applications like DNA separation and protein analysis use electric fields to separate charged particles. The two pistons may carry the opposite charge.

Starting from their respective edges the two pistons will carry opposite electric charges and will move towards each other both with open state, as they move, charged particles go through the holes of one piston and opposite charged particles or non-charged particles are moving through the other piston to the opposite side. When the two pistons meet at point m=c they divide the quantum of fluid to two parts one richer in charged particles, one poorer. Then the two pistons switch to closed state, ready to push each part of the quantum to its respective outlet.

When the two pistons meet, they switch to closed state, the two edges switch to open state, and also the inlet (at point c=m) is switched to open state, then the situation is as follows:

$${P}_{l} ( 1 ) [ x = m ] , {P}_{r} ( 1 ) [ x = m ] , I ( 0 ) , {E}_{l} ( 0 ) , {E}_{r} ( 0 ) \qquad ( i )$$

When the two parts of Q have been pumped out and allowed a new quantum to fill in, the situation is:

$${P}_{l} ( 1 ) [ x = 0 ] , {P}_{r} ( 1 ) [ x = 1 ] , I ( 1 ) , {E}_{l} ( 1 ) , {E}_{r} ( 1 ) \qquad ( ii )$$

### 3.4.5.2 Ion Exchange Chromatography

The piston holes through which the quantum fluid passes may be: (1) constructed with electrically charged resin surface, or (2) may contain trapped resins washed by the flowing MMP quantum fluid.

The sequence here is similar to the change of phase procedure. The higher is moved from x=1 to x=m with open holes containing the resin. In parallel the lower piston without resin, moves with open holes to point m abreast of the higher piston.

At that point, the inlet and the edge openings will be in ‘open’ state, while the moving pistons will shift from open state to closed state:

$${P}_{h} ( 1 ) [ x = m ] , {P}_{l} ( 1 ) [ x = m ] , I ( 0 ) , {E}_{l} ( 0 ) , {E}_{h} ( 0 )$$

The movement of the higher piston from x=1 to x=m through the resin, created a section of Q above the piston where the concentration of resin-affiliated ingredient, A, is higher than it was in the pre processed Q. This section is now separated from the bottom section by having the pistons move, in closed state, each towards its open edge pushing the two parts of Q to their respective collectors. All the while a new Q is flowing in through inlet I.

After a certain number of rounds the resin undergoes elution in a process akin to mixing and reactor handling. After that the resin is once more ready for chromatographic separation.

### 3.4.5.3 Magnetic Separation

If the ingredients in the quantum of fluid are ferromagnetic or paramagnetic or diamagnetic then placing two poles of a magnets near the opposite sides of the MMP will create a separation. This separation may be helped by placing the two pistons in the middle x=0.5, putting both pistons in open state and moving each piston towards its respective edge over a small interval δ, so at most the pistons are at a distance 2δ from each other. One piston at x=0.5−δ, the other at x=0.5+δ. Then immediately turning the pistons around, moving them towards each other to meet at x=0.5, and then repeat. This will create mild inner motion inside the MMP capsule to better allow the magnet to effect the separation.

### 3.4.5.4 In Fluid Electro Magnetic Variations

Some complex fluids may include ingredients with specific affinity or disaffinity, that can be augmented through particular design of fluid passageways and then forcing the fluid to go through these passageways enhancing the separation.

### 3.4.6 Filters and Membranes

Some holes in the piston may be stuffed with a filter or a membrane so that when the fluid is forced to flow through them some ingredients flow better than others, creating a separation step, ending up with two parts of the quantum of fluid Q which are ready to be separated by being pushed by the respective piston to its edge.

### 3.4.7 Surface Based Separation

Adsorption and general surface-based separation are readily MMP implemented by preparing the surfaces of the walls of the passageway to be conditioned for the adsorption discrimination of the fluid that is forced to rush through the passageways.

### 3.5 Storage

A stored fluid may need either (i) comprehensive motion, or (ii) wavy motion. Complex emulsions may need movement to avoid sedimentation and separation. To prevent settling of fluid.

Comprehensive motion can be achieved via a piston as large as the footprint of the fluid container. The piston will move slowly enough up and down, preferably with rotation, impacting motion through the entire stored fluid.

Wave like motion can be achieved via one or more MMP units placed arbitrarily inside the fluid bulk. It may suck in an MMP volume, Q, mix it and push it back out, repeating the same over another MMP quantum. This arrangement mixes small amounts of fluid but sends waves through the bulk each time a quantum of MMP fluid is pumped out back to the stored bulk.

### 3.6 Wave Making

In certain circumstances a quantum of fluids needs to experience a mild waving motion.

This can be done in an MMP capsule by moving the two pistons back and forth across a narrow interval by the middle of the capsule.

### 3.7 Mutual Impact Between Unmixed Fluids

It is a common situation in industrial chemistry, two unmixed fluids are mutually cast in order to enable an impact which may be through material or energy interaction. The common challenge is to achieve intimate contact via separation medium (e.g. a wall). This challenge is hereby met with an MMP capsule wherein the piston contains a stationary or flowing fluid that is touching the passageways from the inner part of the piston. Thereby the passageways in the piston are touching on one hand the MMP quantum fluid and on the other hand the inside piston fluid, so that these two fluids exchange impact of energy, radiation etc. If the passageway material is permeable medium, then a material exchange is possible. The MMP quantum of fluid is having its motion controlled by the size and shape of the passageways and by the motion of the piston. The piston fluid is controlled by a nominal pumping gear that would function while the piston is in motion. With this design one implements an apparatus that allows for highly specific control of flow of two fluids across a separating wall which is in motion optimized to maximize the efficiency of a desired impact between the two fluids. The lateral motion of the piston, a rotational motion of the piston, the open/closed status of the holes in the piston, and the pumping control of the piston fluid allow for efficient impact between the fluids.

Elaboration: Two distinct fluids may exchange energy and matter between them. Such exchange requires contact surface and proper matching of the two fluids across this contact surface. The challenge before us is how to establish enough contact surface and how to move the two fluids on both sides of the surface.

A good solution approach is one where all the parameters are dynamic, the properties of the two fluids and the availability of the separating contract surface.

Recalling that maximum fluid control was achieved with the multi mode piston (MMP), one attempts to deploy the MMP fluid handling approach for the challenge at hand. This can be achieved by turning the walls of the holes in the piston (the fluid passageway) into the separation contact wall with the other fluid filled inside the piston, hugging the first fluid passageway from the outside. Say then that instead of having a block piston with fluid passageways drilled inside, we will have the piston as a fluid container holding a second fluid not mixed with the first. Regarded as MMP+.

In the nominal MMP the piston moves back and forth within a capsule that contains the captured quantum of fluid. In designing the MMP+ one may consider two design options for the piston fluid. It may be a locked quantum inside the piston, or it may be flowing in and out of the piston through a combination of inlet and outlet. The inlet and outlet may be flexible tubes that are pulled and pushed as the piston moves. This flow option for the piston fluid gives more cross fluid impact power, but it is a bit more complex to construct.

This standard construction is subject to optimization using AI

### 3.8 Fluid-Solid Operations

Assorted liquid-solid operations are well handled with the MMP capsule. The most common one is a solid wall separating two liquids for exchange of energy, radiation, as well cross material flow via membrane and filter. The sleeve of the capsule may function as such a between liquid barrier, most commonly for heat exchange. The walls of the holes in the pistons are another example of an in-between wall separating the capsule fluid, Q from the piston fluid that is present in the hollow volume of a piston.

Solid catalysis is another example of fluid-solid interaction. These applications may be served by:
1. plugging a piston hole with a permeable medium through which the capsule fluid, Q is forced to traverse.
2. making the walls of the piston holes of material that applies a separating factor on ingredients in the capsule fluid.

### 4.0 A UNIVERSAL FLUID HANDLING CONSTRUCTION AND METHODOLOGY—FORMAL OVERVIEW

This essence of this invention is formally defined in the following statements:
1. Describing a Fluid Operating System, FOS, constructed to carry out pumping, mixing, diffusing, reacting, separating, waving, and storing fluids; constructed as a fluid containing ‘sleeve’, fitted with one or more pistons capable of independently traversing back and forth inside the sleeve, and where (i) these pistons are drilled with various holes, where each hole can be either in a closed state or in an open state; the holes are drilled from one surface of the piston to the other; in one embodiment the holes are drilled directly into the piston; in another embodiment the holes are drilled onto one or more rotating discs fitted into the piston; in one embodiment the piston has a circular contour and can rotate snugly inside the sleeve;
the lateral movement of each piston, the rotation of each piston, or the rotation of the discs in each piston, as well as switching the status of each hole between open and closed are centrally controlled by an FOS-controller, applying a dedicated power source;
2. The system of statement 1 used as a building block for a fluid operating platform, FOP, capable of carrying out complete chemical processing lines, from raw materials to product, byproduct and refuse, and where the connections between the FOS are either
(i) directly, where fluid from one FOS passes directly to another FOS, or
(ii) indirectly, where between FOS there exists a fluid container into which one FOS is pumping fluid, and from which another FOS fluid is pumped out.
3. The FOS in statement 1 applied for pumping as follows:
let the sleeve be full of fluid; let a and b be two points on the sleeve, with point b further to the right than point a, let the sleeve be fitted with one piston that fits snugly into the sleeve;
(i) let the piston be placed at point a
(ii) let the holes in the piston turn into closed state, marked as: (1)
(iii) let the piston move from point a to point b thereby pumping the fluid between points a and b to further right than point b, and in parallel suck in fluid further left from point a to the section of the sleeve between points a and b;
(iv) while in point b the piston changes the status of its holes from closed to open, marked as (0);
(v) the piston moves back from point b to point a, thereby the fluid between point a and point b is flowing through holes in the piston and remains between points a and b;
this completes a round of pumping fluid in the sleeve from left to right, the piston is back at point a, ready for another round of steps (i) to step (v), repeating indefinitely.
4. The FOS is statement 3 where the sleeve is an arbitrary long pipeline fitted with arbitrary number of pistons that perform the pumping routine in a synchronized way.
5. The FOS in statement 1 applied for mixing as follows:
let the sleeve be full of fluid; let a and b be two points on the sleeve, with point b further to the right than point a, let x measure distance on the sleeve relative to point a: a:x=0, with the distance between points a and b normalized to unit: b: x=1, let the sleeve be fitted with three pistons; piston-a, P′, is placed at point a, with its holes closed: P′(1); piston-b, P″, is placed at point b, with its holes closed, P″(1), and piston m, P, which moves from point a to point b,

$${P}_{x = a} \text{←→} x = b$$

as follows:
(i) piston--m is placed at point a, with its holes in an “open” state, marked as: Pₓ₌ₐ(0)
(ii) Piston-m is moved from point a to point b, during the movement each hole in piston-m is switched arbitrarily between open and closed, so that at any stage of the motion from a to b at least one hole is open; the holes in the m-piston are rotated in an arbitrary speed and arbitrary direction;
as piston-m moves at sufficient speed from point a to point b, the fluid between points a and b is flowing with turbulence from point b to point a and becomes more mixed than before; this is the ‘rightward mix-step’ operation;
(iii) piston-m is moved from point b to point a, during the movement each hole in piston-m is switched arbitrarily between open and closed, so that at any point during the b to a movement at least one hole is open; the holes in the m-piston are rotated in an arbitrary speed and arbitrary direction, as piston-m moves from point b to point a, the fluid between points a and b is flowing with turbulence from point a to point b and becomes more mixed than before this ‘leftward mix-step’ operation;
the combined ‘rightward mix step’ and the ‘leftward mix step’ is considered a ‘mix-round’; when a mix-round is complete, it is ready for another mix round;
by performing an arbitrary number of mix-rounds, t, the fluid between points a and b is mixed to any desired degree.
6. The FOS in statement 1 used to carry out a diffusion operation between two immiscible fluids, one light fluid, L, and one heavy fluid H;
The operation uses a sleeve of length x=1, where piston A is stationary at point a on the sleeve, and piston B is stationary at point b rightward from a on the sleeve, and where the sleeve is terminated by pistons A and B, defined as a capsule with a volume Q;
inside the capsule there are two moving pistons M and M′ in order: A, M, M′, B;
the diffusion operation starts by:
(i) setting the capsule horizontally, setting pistons A and B to open state;
setting pistons M and M′ to closed state, and moving each of them to their respective edge piston: M →A, and M′→B;
(ii) connecting to piston A a reservoir of the lighter fluid, L
(iii) connecting to piston B a reservoir of the heavier, fluid, H
(iv) moving pistons M and M′ one towards the other, thereby pumping the light fluid from the left side of the capsule, and pumping the heavy fluid from the right side of the capsule, pistons M and M′ meeting at point m, a<m<b;
(v) closing pistons A and B;
(vi) setting the capsule vertically with the lighter fluid, L, at the bottom and the heavier fluid, H, at the top; the two fluids are being separated by pistons M and M′ which are adjacent to each other;
(vii) setting pistons M and M′ to open state thereby causing the lighter fluid at the bottom to rise through the open holes in M and M′ to above pistons M and M′, while causing the heavier fluid at the top of the capsule to drop down through the holes to below pistons M and M′; if the heavier fluid is liquid than the lighter fluid forms bubbles as it rises through the heavier fluid, the shape and size of these bubbles is determined by the holes in pistons M and M′;
(viii) when the lighter and heavier fluids exchanged place and the heavier fluid is below pistons M and M′ while the lighter fluid is above pistons M and M′, then the capsule is being flipped to recreate the state of the system following step (vi), thereby defining a diffusion round, which allows one to carry out steps (vii) and (viii) again, perform more diffusion rounds, an arbitrary number of times t;
the more diffusion arounds that are performed, the more advanced is any diffusion that takes place between the lighter fluid and the heavier fluid, since diffusion depends on material crossing surface area and amount of time available for crossing;
following arbitrary number of diffusion rounds,
(viv) the capsule is being turned to horizontal position, pistons M and M′ switch to closed state, the edge pistons A and B switch to open state, one edge piston is connected to a receptacle ready to take in the lighter fluid, and the other edge piston is connected to a receptacle ready to take in the heavier fluid;
(x) pistons M and M′ both in closed state are being moved away from each other, each towards its respective edge piston, and thereby pumping out the contents of the capsule, separating the post-diffusion lighter fluid and heavier fluid;
the capsule being empty, it can repeat steps (i) to (x) over a new quantum of fluid that fills the capsule, comprising an arbitrary ratio of the heavier and lighter fluids.
7. The FOS in statement 1 used to carry out a reaction between fluid reactants, R₁, R₂, . . . Rᵣ to generate one or more developed products, D, one or more developed byproducts D′ and one or more developed refuse D″, using three pistons: Pₐ placed at point a on the sleeve, piston P_{b} placed at point b on the sleeve, where point b is further to the right than point a, and placing piston Pₘ between points a and b, as follows:
(i) match a feeding line for each of the r reactants to at least one hole in piston Pₐ, and keep each matching hole in an ‘open’ state, Pₐ(0);
(ii) Keep piston P_{b} in an open state, P_{b}(0);
(iii) Place piston Pₘ at point a: Pₘ,x=a with all its holes in a closed state: P_{m,x=a}(1);
(iv) Move piston Pₘ from point x=a to point x=b; this pushes any fluid captured between point x=a and x=b to beyond (further right) point x=b, and it sucks in the r reactants R₁, R₂, . . . Rᵣ to the sleeve, captured between point x=a and point x=b, where the relative proportions of the inflowing reactants is determined by the one or more hole through which they flow in, and can be arbitrarily set; the fluid captured in the sleeve between point x=a and x=b is called Q—the operated on quantum of fluid;
(v) close the holes for pistons a and b: Pₐ(1) P_{b}(1);
(vi) switch piston m to ‘open’ state, and move piston m to point x=a;
place the sleeve with Q in conditions conductive to the intended reaction, e.g. temperature, radiation, and exercise a mixing procedure as in claim 5, until the reaction advances as intended and Q contains the product, D, the by products D′ and refuse D′;
(vii) exercise a pumping procedure as in claim 3, thereby Q is pushed beyond point x=b (further to the right), and a new Q comprising reactants R₁, R₂, . . . Rᵣ is sucked into the sleeve between point x=a to point x=b; this concluded a single Q reaction round, with the system ready to exercise successive rounds as desired.
8. The system in statement 1 used to exercise separation of fluid ingredients I₁, I₂, . . . Iᵣ mixed in “input proportions” by constructing the holes in two pistons, Pₘ, Pₘ′ where the latter is further right than the former, such that when the mixture of the r ingredients is flowing through them then members of a group U of these ingredients (U₁, U₂, . . . Uᵤ), is moving faster than members of the complementary group of ingredients, V (V₁, V₂, . . . Vᵥ), where u+v=r;
separation is applied to a quantum of fluid Q mixed in input-proportions, captured between point x=a and x=b on the sleeve, where Q is comprising the U and V groups of ingredients, by operating a FOS separation unit (FOS-SU) as follows:
(i) set pistons a and b to points x=a and x=b respectively both in a closed state. P_{a,x=a}(1), P_{b,x=b}(1);
(ii) move pistons Pₘ and Pₘ′ to x=a while both pistons are in open state;
(iii) move pistons m and piston m′ next to each other, from point x=a to point x=m where m is half point between points a and b, such that 0.5Q is left behind, between x=a and x=m, and the other 0.5Q is captured between point x=m and point x=b; thereby the 0.5Q on the left, between x=a and x=m is richer in group U relative to the proportion before this procedure, and the 0.5Q on the right, between x=m and x=b is richer in group V relative to the proportions before this procedure;
(iv) attach to one or more holes in P_{b} a receptacle, Gᵥ to collect the V-rich 0.5Q, and switch the states of these holes to open;
(v) Switch the states of the holes in pistons m′ to close: P_{m′x=m}(1)
(vi) switch the states of the holes in piston Pₐ to open: Pₐₓ₌ₐ(0)
(vᵢ) move Pₘ′ from x=m to x=b thereby the V-rich 0.5Q is pumped into the V receptacle, Gᵥ, and the left side 0.5Q, which is U-richer is sucked into the volume between point x=m to x=b; and new 0.5Q in “input proportions” is sucked into the volume between point x=a and x=m
(vii) close the holes that connect piston P_{b} to receptacle Gᵥ, and open holes on piston P_{b} that are connected to a U-receptacle, Gᵤ;
(viii) close the holes in piston m, Pₘₓ₌ₘ(1), and move it from x=m to x=b thereby the U-rich 0.5Q is pumped to the U receptable, Gᵤ, and another 0.5Q of fluid in “input proportions” is sucked into the volume between x=a to x=m, while the first “input proportion” 0.5Q is sucked from the volume between x=a to x=m to the volume between x=m to x=b, thereby the first Q in “input proportions” was separated to 0.5Q richer in ingredients of group V, pumped into receptacle Gᵥ, and to the second 0.5Q richer in ingredient richer in group U, pumped into receptacle Gᵤ, and the system is filled with another Q at “input proportions” ready for another round of separation.
9. The system in statement 1 used to exercise separation of liquid ingredients I₁, I₂, . . . Iᵣ mixed in “input proportions” under conditions where members of a group U of these ingredients (U₁, U₂, . . . Uᵤ), is more volatile than members of the complementary group of ingredients, V (V₁, V₂, . . . Vᵥ), where u+v=r;
by using a sleeve that extends from point x=0 to point x=1, and fitting two stationary pistons at the two edges: P_{a,x=0}, and P_{b,x=1}, and fitting in the sleeve two pistons, Pₘ, Pₘ′ where the sleeve is vertical and piston Pₘ′ is higher than piston Pₘ, and piston P_{b} is higher than piston Pa;
executing the following separation round:
(i) set pistons m and m′ at x=0, both in closed state: P_{m,x=0}(1), P′_{m,x=0}(1);
(ii) connect one or more holes in Pₐ to fluid container containing the r ingredients in input proportions, and keep these connected holes open, Pₐ(0);
(iii) Move pistons m and m′ together from x=0 to x=m, 0≤m≤1, thereby the fluid mixture of the r ingredients is sucked into the sleeve between x=0 to x=m;
(iv) close piston a, Pₐ(1);
(v) move pistons m and m′ from x=m to x=1; this creates vacuum in the upper volume of the sleeve, from the surface of the fluid at level m, to the position of pistons m and m′ which move to the top of the sleeve, P_{m,x=1}, P_{m′,x=1}; the volume of the sleeve from about level x=m to level x=1 is transformed to a gas mixture richer with the ingredients in set U than in its proportion in the input fluid, and the fluid between x=0 and x=m is richer with ingredients in set V than in its proportion in the input fluid;
(vᵢ) set pistons m and m′ to open: P_{m,x=1}(0), P_{m′,x=1}(0);
(vii) move piston m to the bottom of the sleeve. Pₘₓ₌₁(0) →Pₘₓ₌₀(0);
(viii) move piston m′ to about x=m. P_{m′x=1}(0)→P_{m′x=m}(0)
(ix) close the holes in pistons m and m′: Pₘₓ₌₀(1), P_{m′x=m}(1);
(x) connect one or more holes in piston P_{b} to a receptacle, Gᵤ, to receive the U-rich part of the captured fluid, Q, and set these holes to ‘open’;
(xi) move pistons m and m′ upward: Pₘₓ₌₀→P_{m,x=m}; P_{m′,x=m}→P_{m′,x=1}, thereby the upper part of Q, richer with U is pumped into the U receptacle, Gᵤ; and new liquid at input proportions is sucked in through Pₐ to fill the volume from x=0 to x=m;
(xii) close the holes in P_{b} that connect to Gᵤ
(xiii) set piston m′ to open, and connect one or more holes in piston P_{b} to a receptacle, Gᵥ, to receive the V-rich part of the captured fluid, Q, and set these holes to ‘open’;
(xiv) move piston m from x=m to x=1, thereby the V-rich part of Q is pumped into the V receptacle, Gᵥ, and new liquid at input proportions is sucked in through Pₐ to fill the volume from x=0 to x=1;
this concludes one round of volatility-based separation.
10. The system in statement 8 applied iteratively to achieve a desired degree of separation as follows:
(i) the input-proportions for Q marked as “0”, is processed in an FOS-SU to U-rich 0.5Q marked “+1” and to V-rich 0.5Q marked “−1”; by processing another “0” Q, Gᵤ contains a Q of U-rich fluid marked “+1” and G, contains a Q of V-rich fluid marked “−1”;
The “+1” Q is processed via an FOS-SU to generate 0.5Q of U rich fluid marked “+2” and to 0.5Q of V rich fluid marked “0”; by processing another “+1” Q via an FOS-SU one generates Q of +2 fluid, and Q of “0” fluid which is re-routed to the input stream of input-proportions “0” fluid;
the “+2” Q fluid is rerouted to an FOS-SU to generate 0.5Q U-rich fluid at degree “+3” and a V-richer fluid, marked “+1”; the latter is added to the “+1” input stream, and the “+3” is either sufficiently U-enriched, or is being recycled again to generate U-richness at higher degree “+4”, and so on until the desired separation is achieved;
a symmetric sequence of operations is carried out with the V-enriched fluid to generate a fluid of desired V-rich status.
11. The FOS is statement 8 wherein the distinction between group U and group V is specific weight; and in order to amplify the separation capacity of the FOS, it is put at the payload end of a centrifuge, such that the faster the centrifuge rotates the greater the weight distinction between group U and group V, and the more efficient the separation.
12. The FOS in statement 1 wherein the sleeve is fitted with two stationary edge pistons A and B at both ends and one or more moving pistons between A and B; such construction is designated as Multi Mode Piston Capsule, or MMP-Capsule, or Capsule;
and where two capsules: C1 and C2 are attached so that piston B of C1 is tightly attached to piston A of C2; and where a third capsule C3 is similarly connected with its piston A of C3 snugly attached to piston B of C2, and so on, connecting arbitrary number of capsules;
and wherein C1 and C2 can be connected such that the two sleeves are aligned in an arbitrary angle α, and the shapes of pistons b for C1 and piston a for C2 are constructed such that these two pistons fit snugly one to the other;
and wherein for α=90° an arbitrary size three-dimensional construction of capsules is assembled.
13. The FOS in statement 1 where the sleeve is a closed ring with arbitrary number of pistons inside, and where one or more inlets are fitted into the ring, and also one or more outlets.
14. The FOS in statement 12 where the capsule is shaped like a rectangular bar, the piston is rectangular with one or more rotating discs with holes, and where two such capsules may be attached one to the other along their sleeve, and at one or more locations each capsule is fit with a hole that allows fluid to flow back and forth from one capsule to the other, and each such hole may be either in an open state or a closed state, controlled by a central controller;
and where such flow-through connection between two capsules is extended to an arbitrary number of capsules, to create a packed construction of capsules of arbitrary number of capsules of arbitrary size in either two-dimensional form or a in a three-dimensional form.
15. The FOS in statement 1 used for operations requiring intimate contact between the capsule fluid, Q, and a solid surface, wherein:
(i) this surface is the walls of the piston holes, embodied by constructing the piston as a hollow chamber with a piston-fluid inlet and a piston-fluid outlet, through which a piston fluid is pumped into the moving piston such that the walls of the piston holes separate between the capsule fluid that flows through the holes of the pistons, and the piston fluid, that flows inside the piston, thereby enabling exchange of material, energy, radiation in any combination, between the two fluids; or:
(ii) wherein the surface dissolves into the capsule fluid for the case where the dissolving solid is placed inside the capsule, or for the case where the piston is built from the dissolving solid, and is being consumed as the piston is moving back and forth letting the capsule fluid flow through the expanding, dissolving holes;
also, the solid surface may be embodied in a porous sieve, filter, membrane that is installed in piston holes so that capsule liquid flowing through that hole will establish intimate contact with the surface of the inserted solid element.
16. The FOS in statement 1 wherein the piston is moved inside the sleeve by wrapping the sleeve with successive metal rings which become subjected to alternate electrical current, one ring after the other, this current applies a magnetic force on a metal ring placed in the piston and thereby moving it through the range of sleeve rings.

What is claimed is:

1. A Fluid Operating System, FOS, constructed to carry out pumping, mixing, diffusing, reacting, separating, waving, and storing fluids; constructed as a fluid containing ‘sleeve’, fitted with one or more pistons capable of independently moving back and forth inside the sleeve, and where (i) these pistons are drilled with various holes, where each hole can be either in a closed state or in an open state; the holes are drilled from one surface of the piston to the other; in one embodiment the holes are drilled directly into the piston; in another embodiment the holes are drilled onto one or more rotating discs fitted into the piston; in one embodiment the piston has a circular contour and can rotate snugly inside the sleeve;
the lateral movement of each piston, the rotation of each piston, or the rotation of the discs in each piston, as well as switching the status of each hole between open and closed are centrally controlled by an FOS-controller, applying a dedicated power source.

2. The system of claim 1 used as a building block for a fluid operating platform, FOP, capable of carrying out complete chemical processing lines, from raw materials to product, byproduct and refuse, and where the connections between the FOS are either
(i) directly, where fluid from one FOS passes directly to another FOS, or
(ii) indirectly, where between FOS there exists a fluid container into which one FOS is pumping fluid, and from which another FOS fluid is pumped out.

3. The FOS in claim 1 applied for pumping as follows:
let the sleeve be full of fluid; let a and b be two points on the sleeve, with point b further to the right than point a, let the sleeve be fitted with one piston that fits snugly into the sleeve;
(i) let the piston be placed at point a
(ii) let the holes in the piston turn into closed state, marked as: (1)
(iii) let the piston move from point a to point b thereby pumping the fluid between points a and b to further right than point b, and in parallel suck in fluid further left from point a to the section of the sleeve between points a and b;
(iv) while in point b the piston changes the status of its holes from closed to open, marked as (0);
(v) the piston moves back from point b to point a, thereby the fluid between point a and point b is flowing through holes in the piston and remains between points a and b;
this completes a round of pumping fluid in the sleeve from left to right, the piston is back at point a, ready for another round of steps (i) to step (v), repeating indefinitely.

4. The FOS is claim 3 where the sleeve is an arbitrary long pipeline fitted with arbitrary number of pistons that perform the pumping routine in a synchronized way.

5. The FOS in claim 1 applied for mixing as follows:
let the sleeve be full of fluid; let a and b be two points on the sleeve, with point b further to the right than point a, let x measure distance on the sleeve relative to point a: a:x=0, with the distance between points a and b normalized to unit: b: x=1, let the sleeve be fitted with three pistons; piston-a, P′, is placed at point a, with its holes closed: P′(1); piston-b, P″, is placed at point b, with its holes closed, P″(1), and piston m, P, which moves from point a to point b,
$${P}_{x = a} \text{←→} x = b$$
as follows:
(i) piston--m is placed at point a, with its holes in an “open” state, marked as: Pₓ₌ₐ(O)
(ii) Piston-m is moved from point a to point b, during the movement each hole in piston-m is switched arbitrarily between open and closed, so that at any stage of the motion from a to b at least one hole is open; the holes in the m-piston are rotated in an arbitrary speed and arbitrary direction;
as piston-m moves at sufficient speed from point a to point b, the fluid between points a and b is flowing with turbulence from point b to point a and becomes more mixed than before; this is the ‘rightward mix-step’ operation;
(iii) piston-m is moved from point b to point a, during the movement each hole in piston-m is switched arbitrarily between open and closed, so that at any point during the b to a movement at least one hole is open; the holes in the m-piston are rotated in an arbitrary speed and arbitrary direction, as piston-m moves from point b to point a, the fluid between points a and b is flowing with turbulence from point a to point b and becomes more mixed than before this ‘leftward mix-step’ operation;
the combined ‘rightward mix step’ and the ‘leftward mix step’ is considered a ‘mix-round’; when a mix-round is complete, it is ready for another mix round;
by performing an arbitrary number of mix-rounds, t, the fluid between points a and b is mixed to any desired degree.

6. The FOS in claim 1 used to carry out a diffusion operation between two immiscible fluids, one light fluid, L, and one heavy fluid H;
The operation uses a sleeve of length x=1, where piston A is stationary at point a on the sleeve, and piston B is stationary at point b rightward from a on the sleeve, and where the sleeve is terminated by pistons A and B, defined as a capsule with a volume Q;
inside the capsule there are two moving pistons M and M′ in order: A, M, M′, B;
the diffusion operation starts by:
(i) setting the capsule horizontally, setting pistons A and B to open state;
setting pistons M and M′ to closed state, and moving each of them to their respective edge piston: M→A, and M′→B;
(ii) connecting to piston A a reservoir of the lighter fluid, L
(iii) connecting to piston B a reservoir of the heavier, fluid, H
(iv) moving pistons M and M′ one towards the other, thereby pumping the light fluid from the left side of the capsule, and pumping the heavy fluid from the right side of the capsule, pistons M and M′ meeting at point m, a<m<b;
(v) closing pistons A and B;
(vᵢ) setting the capsule vertically with the lighter fluid, L, at the bottom, and the heavier fluid, H, at the top; the two fluids are being separated by pistons M and M′ which are adjacent to each other;
(vii) setting pistons M and M′ to open state thereby causing the lighter fluid at the bottom to rise through the open holes in M and M′ to above pistons M and M′, while causing the heavier fluid at the top of the capsule to drop down through the holes to below pistons M and M′; if the heavier fluid is liquid than the lighter fluid forms bubbles as it rises through the heavier fluid, the shape and size of these bubbles is determined by the holes in pistons M and M′;
(viii) when the lighter and heavier fluids exchanged place and the heavier fluid is below pistons M and M′ while the lighter fluid is above pistons M and M′, then the capsule is being flipped to recreate the state of the system following step (vᵢ), thereby defining a diffusion round, which allows one to carry out steps (vii) and (viii) again, perform more diffusion rounds, an arbitrary number of times t;
the more diffusion arounds that are performed, the more advanced is any diffusion that takes place between the lighter fluid and the heavier fluid, since diffusion depends on material crossing surface area and amount of time available for crossing;
following arbitrary number of diffusion rounds,
(viv) the capsule is being turned to horizontal position, pistons M and M′ switch to closed state, the edge pistons A and B switch to open state, one edge piston is connected to a receptacle ready to take in the lighter fluid, and the other edge piston is connected to a receptacle ready to take in the heavier fluid;
(x) pistons M and M′ both in closed state are being moved away from each other, each towards its respective edge piston, and thereby pumping out the contents of the capsule, separating the post-diffusion lighter fluid and heavier fluid;
the capsule being empty, it can repeat steps (i) to (x) over a new quantum of fluid that fills the capsule, comprising an arbitrary ratio of the heavier and lighter fluids.

7. The FOS in claim 1 used to carry out a reaction between fluid reactants, R₁, R₂, . . . Rᵣ to generate one or more developed products, D, one or more developed byproducts D′ and one or more developed refuse D″, using three pistons: Pₐ placed at point a on the sleeve, piston P_{b} placed at point b on the sleeve, where point b is further to the right than point a, and placing piston Pₘ between points a and b, as follows:
(i) match a feeding line for each of the r reactants to at least one hole in piston Pₐ, and keep each matching hole in an ‘open’ state, Pₐ(0);
(ii) Keep piston P_{b} in an open state, P_{b}(0);
(iii) Place piston Pₘ at point a: P_{m,x=a} with all its holes in a closed state: P_{m,x=a}(1);
(iv) Move piston Pₘ from point x=a to point x=b; this pushes any fluid captured between point x=a and x=b to beyond (further right) point x=b, and it sucks in the r reactants R₁, R₂, . . . Rᵣ to the sleeve, captured between point x=a and point x=b, where the relative proportions of the inflowing reactants is determined by the one or more hole through which they flow in, and can be arbitrarily set; the fluid captured in the sleeve between point x=a and x=b is called Q—the operated on quantum of fluid;
(v) close the holes for pistons a and b: Pₐ(1) P_{b}(1);
(vᵢ) switch piston m to ‘open’ state, and move piston m to point x=a;
place the sleeve with Q in conditions conductive to the intended reaction, which are temperature, radiation, and exercise a mixing procedure as in claim 5, until the reaction advances as intended and Q contains the product, D, the by products D′ and refuse D′;
(vii) exercise a pumping procedure as in claim 3, thereby Q is pushed beyond point x=b (further to the right), and a new Q comprising reactants R₁, R₂, . . . Rᵣ is sucked into the sleeve between point x=a to point x=b; this concluded a single Q reaction round, with the system ready to exercise successive rounds as desired;
(viii) the pumped out Q containing the products, the by-products and the refuse is undergoing a separation routine as described in claim 8.

8. The system in claim 1 used to exercise separation of fluid ingredients I₁, I₂, . . . Iᵣ mixed in “input proportions” by constructing the holes in two pistons, Pₘ, Pₘ′ where the latter is further right than the former, such that when the mixture of the r ingredients is flowing through them then members of a group U of these ingredients (U₁, U₂, . . . Uᵤ), is moving faster than members of the complementary group of ingredients, V (V₁, V₂, . . . Vᵥ), where u+v=r;
separation is applied to a quantum of fluid Q mixed in input-proportions, captured between point x=a and x=b on the sleeve, where Q is comprising the U and V groups of ingredients, by operating a FOS separation unit (FOS-SU) as follows:
(i) set pistons a and b to points x=a and x=b respectively both in a closed state. P_{a,x=a}(1), P_{b,x=b}(1);
(ii) move pistons Pₘ and Pₘ′ to x=a while both pistons are in open state;
(iii) move pistons m and piston m′ next to each other, from point x=a to point x=n where n is half point between points a and b, such that 0.5Q is left behind, between x=a and x=n, and the other 0.5Q is captured between point x=n and point x=b; thereby the 0.5Q on the left, between x=a and x=n is richer in group U relative to the proportion before this procedure, and the 0.5Q on the right, between x=n and x=b is richer in group V relative to the proportions before this procedure;
(iv) attach to one or more holes in P_{b} a receptacle, G, to collect the V-rich 0.5Q, and switch the states of these holes to open;
(v) Switch the states of the holes in pistons m′ to close: P_{m′,x=n}(1)
(vᵢ) switch the states of the holes in piston Pₐ to open: P_{a,x=a}(0)
(vᵢ) move Pₘ′ from x=n to x=b thereby the V-rich 0.5Q is pumped into the V receptacle, Gᵥ, and the left side 0.5Q, which is U-richer is sucked into the volume between point x=n to x=b; and new 0.5Q in “input proportions” is sucked into the volume between point x=a and x=n
(vii) close the holes that connect piston P_{b} to receptacle Gᵥ, and open holes on piston P_{b} that are connected to a U-receptacle, Gᵤ;
(viii) close the holes in piston m, P_{m,x=n}(1), and move it from x=n to x=b thereby the U-rich 0.5Q is pumped to the U receptable, Gᵤ, and another 0.5Q of fluid in “input proportions” is sucked into the volume between x=a to x=n, while the first “input proportion” 0.5Q is sucked from the volume between x=a to x=n to the volume between x=n to x=b, thereby the first Q in “input proportions” was separated to 0.5Q richer in ingredients of group V, pumped into receptacle Gᵥ, and to the second 0.5Q richer in ingredient richer in group U, pumped into receptacle Gᵤ, and the system is filled with another Q at “input proportions” ready for another round of separation.

9. The system in claim 1 used to exercise separation of liquid ingredients I₁, I₂, . . . Iᵣ mixed in “input proportions” under conditions where members of a group U of these ingredients (U₁, U₂, . . . Uᵤ), are more volatile than members of the complementary group of ingredients, V (V₁, V₂, . . . Vᵥ), where u+v=r;
by using a sleeve that extends from point x=0 to point x=1, and fitting two stationary pistons at the two edges: P_{a,x=0}, and P_{b,x=1}, and fitting in the sleeve two pistons, Pₘ, Pₘ′ where the sleeve is vertical and piston Pₘ′ is higher than piston Pₘ, and piston P_{b} is higher than piston Pa;
executing the following separation round:
(i) set pistons m and m′ at x=0, both in closed state: P_{m,x=0}(1), P′_{m,x=0}(1);
(ii) connect one or more holes in Pₐ to fluid container containing the r ingredients in input proportions, and keep these connected holes open, Pₐ(0);
(iii) Move pistons m and m′ together from x=0 to x=n, 0≤n≤1, thereby the fluid mixture of the r ingredients is sucked into the sleeve between x=0 to x=n;
(iv) close piston a, Pₐ(1);
(v) move pistons m and m′ from x=m to x=1; this creates vacuum in the upper volume of the sleeve, from the surface of the fluid at level n, to the position of pistons m and m′ which move to the top of the sleeve, P_{m,x=1}, P_{m′,x=1}; the volume of the sleeve from about level x=n to level x=1 is transformed to a gas mixture richer with the ingredients in set U than in its proportion in the input fluid, and the fluid between x=0 and x=n is richer with ingredients in set V than in its proportion in the input fluid;
(vᵢ) set pistons m and m′ to open: P_{m,x=1}(0), P_{m′,x=1}(0);
(vii) move piston m to the bottom of the sleeve. P_{m,x=1}(0) →P_{m,x=0}(0);
(viii) move piston m′ to about x=m. P_{m′,x=1}(0)→P_{m′,x=n}(0)
(ix) close the holes in pistons m and m′: P_{m,x=0}(1), P_{m′,x=n}(1);
(x) connect one or more holes in piston P_{b} to a receptacle, Gᵤ, to receive the U-rich part of the captured fluid, Q, and set these holes to ‘open’;
(xᵢ) move pistons m and m′ upward: P_{m,x=0}→P_{m,x=n}; P_{m′,x=n}→P_{m′,x=1}, thereby the upper part of Q, richer with U is pumped into the U receptacle, Gᵤ; and new liquid at input proportions is sucked in through Pₐ to fill the volume from x=0 to x=n;
(xii) close the holes in P_{b} that connect to Gᵤ
(xiii) set piston m′ to open, and connect one or more holes in piston P_{b} to a receptacle, Gᵥ, to receive the V-rich part of the captured fluid, Q, and set these holes to ‘open’;
(xiv) move piston m from x=n to x=1, thereby the V-rich part of Q is pumped into the V receptacle, Gᵥ, and new liquid at input proportions is sucked in through Pₐ to fill the volume from x=0 to x=1;
this concludes one round of volatility-based separation.

10. The system in claim 8 applied iteratively to achieve a desired degree of separation as follows:
(i) the input-proportions for Q marked as “0”, is processed in an FOS-SU to U-rich 0.5Q marked “+1” and to V-rich 0.5Q marked “−1”;
processing another “0” Q, so that Gᵤ contains a Q of U-rich fluid marked “+1” and Gᵥ contains a Q of V-rich fluid marked “−1”;
The “+1” Q is processed via an FOS-SU to generate 0.5Q of U rich fluid marked “+2” and to 0.5Q of V rich fluid marked “0”; by processing another “+1” Q via an FOS-SU one generates Q of +2 fluid, and Q of “0” fluid which is re-routed to the input stream of input-proportions “0” fluid;
the “+2” Q fluid is rerouted to an FOS-SU to generate 0.5Q U-rich fluid at degree “+3” and a V-richer fluid, marked “+1”; the latter is added to the “+1” input stream, and the “+3” is either sufficiently U-enriched, or is being recycled again to generate U-richness at higher degree “+4”, and so on until the desired separation is achieved;
a symmetric sequence of operations is carried out with the V-enriched fluid to generate a fluid of desired V-rich status.

11. The FOS is claim 8 wherein the distinction between group U and group V is specific weight; and in order to amplify the separation capacity of the FOS, it is put at the payload end of a centrifuge, such that the faster the centrifuge rotates the greater the weight distinction between group U and group V, and the more efficient the separation.

12. The FOS in claim 1 wherein the sleeve is fitted with two stationary edge pistons A and B at both ends and one or more moving pistons between A and B; such construction is designated as Multi Mode Piston Capsule, or MMP-Capsule, or Capsule;
and where two capsules are constructed to allow fluid to pass between the capsules, “Cross Capsule Construction” as follows: capsule C1 and capsule C2 are attached so that piston B of C1 and piston A of C2 have a tight touching position, so fluid passing through one of the pistons directly passes through the other; “Cross Piston Construction”, and where a third capsule C3 is similarly connected with its piston A of C3 built with a Cross Piston Construction with piston B of C2, and so on, connecting arbitrary number of capsules for fluid to pass from one capsule to the next, or from one capsule to the previous;
and wherein a Cross Capsule Construction is done as follows: capsules C1 and C2 are connected such that the two sleeves are aligned in an arbitrary angle α, and the shapes of pistons B for C1 and piston A for C2 are constructed such that these two pistons establish a Cross Piston Construction;
and wherein a Cross Capsule Construction is done for α=90° an arbitrary size three-dimensional construction of capsules is assembled comprising arbitrary number of capsules; where one or more capsules are stretched along the X axis, one or more capsules are stretched along the Y axis, and one or more capsules are stretched along the Z axis.

13. The FOS in claim 1 where the sleeve is a closed ring with arbitrary number of pistons inside, and where one or more inlets are fitted into the ring, and also one or more outlets.

14. The FOS in claim 12 where the capsule is shaped like a rectangular bar, the piston is rectangular with one or more rotating discs with holes, and where two such capsules are attached one to the other along their sleeves, and at one or more matching locations on both sleeves each capsule is fit with a hole that allows fluid to flow back and forth from one capsule to the other, and each such hole may be either in an open state or a closed state, controlled by a central controller;
and where such flow-through connection between two capsules is extended to an arbitrary number of capsules, to create a packed construction of capsules of arbitrary number of capsules of arbitrary size in either two-dimensional form or a in a three-dimensional form.

15. The FOS in claim 1 used for operations requiring intimate contact between the capsule fluid, Q, and a solid surface, wherein:
(i) this surface is the walls of the piston holes, embodied by constructing the piston as a hollow chamber with a piston-fluid inlet and a piston-fluid outlet, through which a piston fluid is pumped into the moving piston such that the walls of the piston holes separate between the capsule fluid that flows through the holes of the pistons, and the piston fluid, that flows inside the piston, thereby enabling exchange of material, energy, radiation, in any combination, between the two fluids; or:
(ii) wherein the surface dissolves into the capsule fluid for the case where the dissolving solid is placed inside the capsule, or for the case where the piston is built from the dissolving solid, and is being consumed as the piston is moving back and forth letting the capsule fluid flow through the expanding, dissolving holes;
also, the solid surface is embodied in a porous sieve, filter, membrane that is installed in piston holes so that capsule liquid flowing through that hole will establish intimate contact with the surface of the inserted solid element.

16. The FOS in claim 1 wherein the piston is moved inside the sleeve by wrapping the sleeve with successive metal rings which become subjected to alternate electrical current, one ring after the other, this current applies a magnetic force on a metal ring placed in the piston and thereby moving it through the range of sleeve rings.
